(19) United States
(12) Patent Application Publication
(10) Pub. No.: US 2024/0080843 A1
(43) Pub. Date: Mar. 7, 2024

(54) MAC CE SIGNALING FOR DOWNLINK AND UPLINK TCI STATE ACTIVATION

(71) Applicant: Telefonaktiebolaget LM Ericsson (publ), Stockholm (SE)

(72) Inventors: Siva Muruganathan, Stittsville (CA); Helka-Liina Määttänen, Espoo (FI); Claes Tidestav, Bålsta (SE); Shiwei Gao, Nepean (CA)

(21) Appl. No.: 18/269,979

(22) PCT Filed: Dec. 30, 2021
(86) PCT No.: PCT/IB2021/062495

§ 371 Date: Jun. 28, 2023

Related U.S. Application Data
(60) Provisional application No. 63/132,091, filed on Dec. 30, 2020.

(51) Int. Cl. H04W 72/20; H04L 5/00

(52) U.S. Cl. CPC H04W 72/20; H04L 5/0091

(57) ABSTRACT

Systems and methods of the present disclosure are directed to a method performed by a wireless communication device (WCD). The method includes receiving, from a Radio Access Network (RAN) node, a Medium Access Control (MAC) Control Element (CE) that includes information. The information indicates a plurality of activated Transmission Configuration Indicator (TCI) states for the WCD including at least one Downlink (DL) TCI state and at least one Uplink (UL) TCI state. The information maps each activated TCI state of the plurality of activated TCI states to one of a plurality of codepoints of a TCI field in a Downlink Control Information (DCI).

### RELATED APPLICATIONS

This application claims the benefit of provisional patent application Ser. No. 63/132,091, filed Dec. 30, 2020, the disclosure of which is hereby incorporated herein by reference in its entirety.

### TECHNICAL FIELD

The present disclosure relates to Medium Access Control (MAC) Control Element (CE) signaling and, more specifically, utilization of MAC CEs for mapping of activated Transmission Configuration Indicator (TCI) states and codepoints.

### BACKGROUND

### New Radio (NR)

The Fifth Generation (5G) mobile wireless communication system or New Radio (NR) supports a diverse set of use cases and a diverse set of deployment scenarios.

NR uses Cyclic Prefix Orthogonal Frequency Division Multiplexing (OFDM), or CP-OFDM, in the downlink (i.e., from a network node, gNB, eNB, or base station, to a user equipment (UE)) and both CP-OFDM and Discrete Fourier Transform (DFT)-spread OFDM, or DFT-S-OFDM, in the uplink (i.e., from UE to gNB). In the time domain, NR downlink and uplink physical resources are organized into equally-sized subframes of 1 millisecond (ms) each. A subframe is further divided into multiple slots of equal duration.

The slot length depends on subcarrier spacing. For subcarrier spacing of Δf=15 kHz, there is only one slot per subframe and each slot always consists of 14 OFDM symbols, irrespectively of the subcarrier spacing. FIG. 1 illustrates the NR time-domain structure with 15 kHz subcarrier spacing.

Typical data scheduling in NR are per slot basis. An example is shown in FIG. 1 where the first two symbols contain Physical Downlink Control Channel (PDCCH) and the remaining twelve symbols contain Physical Data Channel (PDCH), either a Physical Downlink Shared Channel (PDSCH) or a Physical Uplink Shared Channel (PUSCH).

Different subcarrier spacing values are supported in NR. The supported subcarrier spacing values (also referred to as different numerologies) are given by Δf=(15×2^{α}) kHz where a is a non-negative integer. Δf=15 kHz is the basic subcarrier spacing that is also used in Long Term Evolution (LTE). The slot durations at different subcarrier spacings are shown in Table 1.

TABLE 1
Slot length at different numerologies.

| | | |
|---|---|---|
| Numerology | Slot length | RB BW |

| | | | | | |
|---|---|---|---|---|---|
| 15 | kHz | 1 | ms | 180 | kHz |
| 30 | kHz | 0.5 | ms | 360 | kHz |
| 60 | kHz | 0.25 | ms | 720 | kHz |
| 120 | kHz | 125 | μs | 1.44 | MHz |
| 240 | kHz | 62.5 | μs | 2.88 | MHz |

In the frequency-domain physical resource definition, a system bandwidth is divided into Resource Blocks (RBs), each corresponding to twelve contiguous subcarriers. The Common RBs (CRBs) are numbered starting with 0 from one end of the system bandwidth. The UE is configured with one or up to four bandwidth parts (BWPs), which may be a subset of the RBs supported on a carrier. Hence, a BWP may start at a CRB larger than zero. All configured BWPs have a common reference, which is the CRB 0. Hence, a UE can be configured a narrow BWP (e.g., 10 Megahertz (MHz)) and a wide BWP (e.g., 100 MHz), but only one BWP can be active for the UE at a given point in time. The Physical RBs (PRB) are numbered from 0 to N−1 within a BWP, but note that the 0:th PRB of a BWP may be the K:th CRB where K>0.

FIG. 2 illustrates a basic NR physical time-frequency resource grid, where only one RB within a 14-symbol slot is shown. One OFDM subcarrier during one OFDM symbol interval forms one Resource Element (RE).

Downlink transmissions can be dynamically scheduled, i.e., in each slot the gNB transmits Downlink Control Information (DCI) over PDCCH about which UE data is to be transmitted to and which RBs in the current downlink slot the data is transmitted on. PDCCH is typically transmitted in the first one or two OFDM symbols in each slot in NR. The UE data is carried on PDSCH. A UE first detects and decodes PDCCH and, if the decoding is successful, it then decodes the corresponding PDSCH based on the decoded DCI in the PDCCH.

Uplink data transmission can also be dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

### QCL and TCI States

In NR, several signals can be transmitted from different antenna ports of a same base station. These signals can have the same large-scale properties such as Doppler shift/spread, average delay spread, or average delay. These antenna ports are then said to be Quasi Co-Located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a Channel State Information Reference Signal (CSI-RS) for Tracking RS (TRS) and the PDSCH Demodulation Reference Signal (DMRS). When UE receives the PDSCH DMRS, the UE can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same receive (Rx) beam to receive them. This is helpful for a UE that uses analog beamforming to receive signals, since the UE needs to adjust its Rx beam in some direction prior to receiving a certain signal. If the UE knows that the signal is spatially QCL with some other signal it has received earlier, then it can safely use the same Rx beam to also receive this signal. Note that for beam management, the discussion mostly revolves around QCL Type D, but it is also necessary to convey a Type A QCL relation for the RSs to the UE, so that it can estimate all the relevant large-scale parameters.

Typically, this is achieved by configuring the UE with a CSI-RS for tracking (TRS) for time/frequency offset estimation. To be able to use any QCL reference, the UE would have to receive it with a sufficiently good Signal to Interference plus Noise Ratio (SINR). In many cases, this means that the TRS must be transmitted in a suitable beam to a certain UE.

To introduce dynamics in beam and Transmission and Reception point (TRP) selection, the UE can be configured through Radio Resource Control (RRC) signaling with up to 128 Transmission Configuration Indicator (TCI) states. FIG. 3 illustrates the TCI state information element as defined in Third Generation Partnership Project (3GPP) Technical Specification (TS) 38.331, NR; RRC; Protocol specification, V16.2.0 (10-2020).

Each TCI state contains QCL information related to one or two RSs. For example, a TCI state may contain CSI-RS1 associated with QCL Type A and CSI-RS2 associated with QCL TypeD. If a third RS, e.g. the PDCCH DMRS, has this TCI state as QCL source, it means that the UE can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates, via a Medium Access Control (MAC) Control Element (CE), one TCI state for PDCCH (i.e., provides a TCI for PDCCH) and up to eight TCI states for PDSCH. The number of active TCI states that the UE supports is a UE capability, but the maximum in the current NR specifications is eight.

Assume a UE has four activated TCI states (from a list of 64 configured TCI states). Hence, sixty TCI states are inactive for this particular UE, and the UE needs not be prepared to have large scale parameters estimated for those inactive TCI states. But the UE continuously tracks and updates the large-scale parameters for the RSs in the four active TCI states. When scheduling a PDSCH to a UE, the DCI contains a pointer to one activated TCI state. The UE then knows which large-scale parameter estimate to use when performing PDSCH DMRS channel estimation and thus PDSCH demodulation.

As long as the UE can use any of the currently activated TCI states, it is sufficient to use DCI signaling. However, at some point in time, none of the RSs in the currently activated TCI states can be received by the UE, i.e., when the UE moves out of the beams in which the RSs in the activated TCI states are transmitted. When this happens (or actually before this happens), the gNB would have to activate new TCI states. Typically, since the number of activated TCI states is fixed, the gNB would also have to deactivate one or more of the currently activated TCI states.

FIG. 4 depicts a two-step procedure related to TCI state update. As illustrated, when an update to the current TCI state is needed, a new TCI state is selected with DCI. If a new set of TCIs states needs to be activated, the gNB activates new TCI states for the UE using a MAC CE.

### TCI States Activation/Deactivation for UE-Specific PDSCH Via MAC CE

Now the details of the MAC CE signaling that is used to activate/deactivate TCI states for UE specific PDSCH are provided. FIG. 5 illustrates the structure of the MAC CE for activating/deactivating TCI states for UE specific PDSCH.

As shown in FIG. 5, the MAC CE contains the following fields:
Serving Cell ID: This field indicates the identity of the Serving Cell for which the MAC CE applies. The length of the field is 5 bits;
BWP ID: This field contains the ID corresponding to a downlink bandwidth part for which the MAC CE applies. The BWP ID is given by the higher layer parameter BWP-Id as specified in 3GPP TS 38.331. The length of the BWP ID field is 2 bits since a UE can be configured with up to 4 BWPs for downlink;
A variable number of fields Tᵢ: If the UE is configured with a TCI state with TCI State ID i, then then the field Tᵢ indicates the activation/deactivation status of the TCI state with TCI State ID i. If the UE is not configured with a TCI state with TCI State ID i, the MAC entity shall ignore the Tᵢ field. The Tᵢ field is set to “1” to indicate that the TCI state with TCI State ID i shall be activated and mapped to the codepoint of the DCI Transmission Configuration Indication field, as specified in 3GPP TS 38.214, Physical layer procedures for data, V16.3.0 (04-2020). The Tᵢ field is set to “0” to indicate that the TCI state with TCI State ID i shall be deactivated and is not mapped to the codepoint of the DCI Transmission Configuration Indication field. It should be noted that the codepoint to which the TCI State is mapped is determined by the ordinal position among all the TCI States with Tᵢ field set to “1”. That is the first TCI State with Tᵢ field set to “1” shall be mapped to the codepoint value 0 of DCI Transmission Configuration Indication field, the second TCI State with Tᵢ field set to “1” shall be mapped to the codepoint value 1 of DCI Transmission Configuration Indication field, and so on. In NR Rel-15, the maximum number of activated TCI states is 8;
A Reserved bit R: this bit is set to ‘0’ in NR Rel-15.

Note that the TCI States Activation/Deactivation for UE-specific PDSCH MAC CE is identified by a MAC PDU subheader with Logical Channel ID (LCID) as specified in Table 6.2.1-1 of 3GPP TS 38.321, NR; MAC protocol specification, V16.2.1, (10-2020). The MAC CE for Activation/Deactivation of TCI States for UE-specific PDSCH has variable size.

### TCI State Indication for UE-Specific PDSCH Via DCI

The gNB can use DCI format 1_1 or 1_2 to indicate to the UE that it shall use one of the activated TCI states for the subsequent PDSCH reception. The field being used in the DCI is Transmission configuration indication, which is 3 bits if td-PresentInDCI is “enabled” or td-PresentForDCI-Format1-2-r16 is present respectively for DCI format 1_1 and DCI 1_2 by higher layer. FIG. 6 illustrates an example of such a DCI indication of a TCI state.

DCI code point 0 indicates the first TCI state index in the list of TCI states, DCI code point 1 indicates the second TCI state index in the list, and so on.

### Multi-DCI Based Multi-TRP

In NR Rel-16, multi-DCI scheduling is for multi-TRP in which a UE may receive two DCIs each scheduling a PDSCH/PUSCH. Each PDCCH and PDSCH are transmitted from the same TRP.

For multi-DCI operation, a UE needs to be configured with two CORESET pools, each associated with a TRP. Each CORESET pool is a collection of CORESETs that belongs to the same pool. A CORESET pool index can be configured in each CORESET with a value of 0 or 1. For the two DCIs in the above example, they are transmitted in two CORESETs belonging to different CORESET pools (i.e., with CORESETPoolIndex 0 and 1 respectively).

### Single-DCI Based Multi-TRP

In Release 16, single-DCI based multi-TRP operation was also specified. In single-DCI based multi-TRP operation, two DL TCI states are associated to one DCI codepoint. That is, when a TCI field codepoint in DCI indicates two TCI states, each TCI state corresponds to a different beam or different TRP. The activation and mapping of 2 TCI states for a codepoint in the TCI field of DCI is done with the MAC CE in clause 6.1.3.24 from 3GPP TS 38.321.

### SUMMARY

Embodiments of a method of activating downlink Transmission Configuration Indication (TCI) states and/or uplink TCI states using a single Medium Access Control (MAC) Control Element (CE) are disclosed. In one embodiment, the method comprises the MAC CE mapping the activated downlink (DL) TCI states and/or uplink (UL) TCI states to a plurality of codepoints of a TCI field of a Downlink Control Information (DCI). A particular codepoint among the plurality of codepoints of the TCI field of the DCI is mapped via the MAC CE to only downlink TCI state(s), only uplink TCI state(s), or to both downlink TCI states and uplink TCI states. Accordingly, embodiments of the present disclosure provide efficient and flexible mechanisms to associate TCI state(s) associated with a codepoint of a TCI field in DCI, therefore results in low signaling overhead for activating DL and/or UL TCI states to a UE.

There are, proposed herein, various embodiments which address one or more of the issues disclosed herein. Embodiments of a method performed by a wireless communication device (WCD) (e.g., a UE) are disclosed herein. In one embodiment, a method performed by a WCD comprises receiving, from a RAN node, a MAC CE that comprises information that: (a) indicates a plurality of activated TCI states for the WCD comprising at least one DL TCI state and at least one UL TCI state and (b) maps each activated TCI state of the plurality of activated TCI states to one of a plurality of codepoints of a TCI field in a DCI.

In one embodiment, the method further comprises receiving a DCI comprising a TCI field set to a particular codepoint of the plurality of codepoints of the TCI field and determining, from the plurality of activated TCI states, a TCI state to be used for reception of a downlink transmission or transmission of an uplink transmission based on the particular codepoint of the TCI field comprised in the received DCI. In one embodiment, the method further comprises performing reception of the downlink transmission or transmission of the uplink transmission based on the determined TCI state.

In one embodiment, for at least one codepoint of the plurality of codepoints of the TCI field, the information comprised in the MAC CE maps an equal number of DL TCI states and UL TCI states to the at least one codepoint. In one embodiment, the equal number of DL TCI states and UL TCI states is one DL TCI state and one UL TCI state. In one embodiment, the information comprised in the MAC CE maps the equal number of DL TCI states and UL TCI states to the at least one codepoint for one Component Carrier (CC)/DL Bandwidth Part (BWP), a set of CCs/DL BWPs, one CC/UL BWP, or a set of CCs/DL BWPs and CCs/UL BWPs. In one embodiment, the information comprised in the MAC CE maps the equal number of DL TCI states and UL TCI states to the at least one codepoint for the set of CCs/DL BWPs or the set of CCs/DL BWPs and CCs/UL BWPs, and the equal number of DL TCI states and UL TCI states are applied to each DL BWP in the set of CCs/DL BWPs or the set of CCs/DL BWPs and CCs/UL BWPs.

In another embodiment, the equal number of DL TCI states and UL TCI states is two DL TCI states and two UL TCI states.

In one embodiment, for at least one codepoint of the plurality of codepoints of the TCI field, the information comprised in the MAC CE maps different numbers of DL TCI states and UL TCI states to the at least one codepoint. In one embodiment, the different numbers of DL TCI states and UL TCI states is two DL TCI states and one UL TCI state. In one embodiment, the two DL TCI states respectively correspond to two beams received from two Transmission/Reception Points, TRPs, in DL, and wherein the one UL TCI state corresponds to a beam transmitted towards one TRP in UL.

In another embodiment, the different numbers of DL TCI states and UL TCI states is one DL TCI state and two UL TCI states. In one embodiment, the one DL TCI states corresponds to a beam received from a TRPs in DL, and wherein the two UL TCI states respectively correspond to two beams transmitted towards two TRPs in UL.

In one embodiment, for at least one codepoint of the plurality of codepoints of the TCI field, the information comprised in the MAC CE maps either one or more DL TCI states or one or more UL TCI states, but not both DL and UL TCI states, to the at least one codepoint.

In one embodiment, the information comprised in the MAC CE comprises, for each codepoint of the plurality of codepoints of the TCI field, one or more bits fields comprising: a first bit field where one bit in the first bit field indicates whether the codepoint is mapped to a first DL TCI state, a second bit field where one bit in the second bit field indicates whether the codepoint is mapped to a second DL TCI state, a third bit field where one bit in the third bit field indicates whether the codepoint is mapped to a first UL TCI state, a fourth bit field where one bit in the fourth bit field indicates whether the codepoint is mapped to a second UL TCI state, or a combination of any two or more of the first, second, third, and fourth bit fields.

In one embodiment, for at least one codepoint of the plurality of codepoints of the TCI field, the WCD is configured with information that indicates a number of DL TCI states to which the codepoint is mapped, information that indicates a number of UL TCI states to which the codepoint is mapped, or both.

In one embodiment, the particular codepoint is mapped to a single DL TCI state in the MAC CE, and the single DL TCI state is applied for all CORESETs configured to the WCD. In another embodiment, the particular codepoint is mapped to a single DL TCI state in the MAC CE, and the single DL TCI state is applied for a subset of all CORESETs configured to the WCD. In another embodiment, the particular codepoint is mapped to two DL TCI states in the MAC CE, a single CORESET is configured for the WCD, and one of the two DL TCI states is applied to the single CORESET. In another embodiment, the particular codepoint is mapped to two DL TCI states in the MAC CE, a single CORESET is configured for the WCD, and both of the two DL TCI states are applied to the single CORESET.

In another embodiment, the particular codepoint is mapped to two (or more) DL TCI states in the MAC CE, two (or more) CORESETs are configured for the WCD, and the two (or more) DL TCI states are applied to the two (or more) CORESETs in a predefined pattern. In another embodiment, the particular codepoint is mapped to two (or more) DL TCI states in the MAC CE, two (or more) CORESETs are configured for the WCD, and all of the two (or more) DL TCI states are applied to each of the two (or more) CORESETs.

In one embodiment, the particular codepoint is mapped to a single UL TCI state in the MAC CE, a PUCCH resource was activated with a single UL TCI state, and the single UL TCI state activated for the PUCCH resource is updated with the single UL TCI state mapped to the particular codepoint in the MAC CE. In another embodiment, the particular codepoint is mapped to a single UL TCI state in the MAC CE, a PUCCH resource was activated with two (or more) UL TCI states, and one of the two (or more) UL TCI states activated for the PUCCH resource is updated with the single UL TCI state mapped to the particular codepoint in the MAC CE.

In one embodiment, the particular codepoint is mapped to a two (or more) UL TCI states in the MAC CE, one of the two (or more) UL TCI states is mapped to SRS resources in a first SRS resource set and another of the two (or more) UL TCI states is mapped to SRS resources in a second SRS resource set. In one embodiment, the first and second SRS resource sets are configured for codebook or non-codebook based PUSCH transmissions.

In one embodiment, the information comprised in the MAC CE comprises, for each codepoint of the plurality of codepoints of the TCI field: one or more first TCI state IDs that indicate one or more activated DL TCI states mapped to the codepoint and one or more second TCI state IDs that indicate one or more activated UL TCI states mapped to the codepoint.

In one embodiment, at least one DL TCI state is mapped to each codepoint of the plurality of codepoints of the TCI field, and the information comprised in the MAC CE comprises, for each codepoint of the plurality of codepoints of the TCI field: a first bit field that indicates whether a second DL TCI state is mapped to the codepoint in the MAC CE, a second bit field that indicates whether a first UL TCI state is mapped to the codepoint in the MAC CE, and a third bit field that indicates whether a second UL TCI state is mapped to the codepoint in the MAC CE.

In one embodiment, at least one DL TCI state and at least one UL TCI state are mapped to each codepoint of the plurality of codepoints of the TCI, and the information comprised in the MAC CE comprises, for each codepoint of the plurality of codepoints of the TCI field, a first bit field that indicates whether a second DL TCI state is mapped to the codepoint in the MAC CE and a second bit field that indicates whether a second UL TCI state is mapped to the codepoint in the MAC CE.

In one embodiment, at least one DL TCI state is mapped to each codepoint of the plurality of codepoints of the TCI field, and the information comprised in the MAC CE comprises, for each codepoint of the plurality of codepoints of the TCI field: a first bit field that indicates whether a first DL TCI state is mapped to the codepoint in the MAC CE, a second bit field that indicates whether a second DL TCI state is mapped to the codepoint in the MAC CE, a third bit field that indicates whether a first UL TCI state is mapped to the codepoint in the MAC CE, and a fourth bit field that indicates whether a second UL TCI state is mapped to the codepoint in the MAC CE.

Corresponding embodiments of a WCD are also disclosed. In one embodiment, a WCD is adapted to receive, from a RAN node, a MAC CE that comprises information that: (a) indicates a plurality of activated TCI states for the WCD comprising at least one DL TCI state and at least one UL TCI state and (b) maps each activated TCI state of the plurality of activated TCI states to one of a plurality of codepoints of a TCI field in a DCI.

In another embodiment, a WCD comprises one or more transmitters, one or more receivers, and processing circuitry associated with the one or more transmitters and the one or more receivers. The processing circuitry is configured to cause the WCD to receive, from a RAN node, a MAC CE that comprises information that: (a) indicates a plurality of activated TCI states for the WCD comprising at least one DL TCI state and at least one UL TCI state and (b) maps each activated TCI state of the plurality of activated TCI states to one of a plurality of codepoints of a TCI field in a DCI.

Embodiments of a method performed by a RAN node are also disclosed. In one embodiment, a method performed by a RAN node comprises sending, to a WCD, a MAC CE that comprises information that: (a) indicates a plurality of activated TCI states for the WCD comprising at least one DL TCI state and at least one UL TCI state and (b) maps each activated TCI state of the plurality of activated TCI states to one of a plurality of codepoints of a TCI field in a DCI.

In one embodiment, the method further comprises sending, to the WCD, a DCI comprising a TCI field set to a particular codepoint of the plurality of codepoints of the TCI field.

In one embodiment, for at least one codepoint of the plurality of codepoints of the TCI field, the information comprised in the MAC CE maps an equal number of DL TCI states and UL TCI states to the at least one codepoint. In one embodiment, the equal number of DL TCI states and UL TCI states is one DL TCI state and one UL TCI state. In one embodiment, the information comprised in the MAC CE maps the equal number of DL TCI states and UL TCI states to the at least one codepoint for one CC/DL BWP, a set of CCs/DL BWPs, one CC/UL BWP, or a set of CCs/DL BWPs and CCs/UL BWPs. In one embodiment, the information comprised in the MAC CE maps the equal number of DL TCI states and UL TCI states to the at least one codepoint for the set of CCs/DL BWPs or the set of CCs/DL BWPs and CCs/UL BWPs, and the equal number of DL TCI states and UL TCI states are applied to each DL BWP in the set of CCs/DL BWPs or the set of CCs/DL BWPs and CCs/UL BWPs.

In another embodiment, the equal number of DL TCI states and UL TCI states is two DL TCI states and two UL TCI states.

In one embodiment, for at least one codepoint of the plurality of codepoints of the TCI field, the information comprised in the MAC CE maps different numbers of DL TCI states and UL TCI states to the at least one codepoint. In one embodiment, the different numbers of DL TCI states and UL TCI states is two DL TCI states and one UL TCI state. In another embodiment, the different numbers of DL TCI states and UL TCI states is one DL TCI state and two UL TCI states.

In one embodiment, for at least one codepoint of the plurality of codepoints of the TCI field, the information comprised in the MAC CE maps either one or more DL TCI states or one or more UL TCI states, but not both DL and UL TCI states, to the at least one codepoint.

In one embodiment, the information comprised in the MAC CE comprises, for each codepoint of the plurality of codepoints of the TCI field, one or more bits fields comprising: a first bit field where one bit in the first bit field indicates whether the codepoint is mapped to a first DL TCI state, a second bit field where one bit in the second bit field indicates whether the codepoint is mapped to a second DL TCI state, a third bit field where one bit in the third bit field indicates whether the codepoint is mapped to a first UL TCI state, a fourth bit field where one bit in the fourth bit field indicates whether the codepoint is mapped to a second UL TCI state, or a combination of any two or more of the first, second, third, and fourth bit fields.

In one embodiment, for at least one codepoint of the plurality of codepoints of the TCI, the WCD is configured with information that indicates a number of DL TCI states to which the codepoint is mapped, information that indicates a number of UL TCI states to which the codepoint is mapped, or both.

In one embodiment, the information comprised in the MAC CE comprises, for each codepoint of the plurality of codepoints of the TCI field: one or more first TCI state IDs that indicate one or more activated DL TCI states mapped to the codepoint and one or more second TCI state IDs that indicate one or more activated UL TCI states mapped to the codepoint.

In one embodiment, at least one DL TCI state is mapped to each codepoint of the plurality of codepoints of the TCI field, and the information comprised in the MAC CE comprises, for each codepoint of the plurality of codepoints of the TCI field: a first bit field that indicates whether a second DL TCI state is mapped to the codepoint in the MAC CE, a second bit field that indicates whether a first UL TCI state is mapped to the codepoint in the MAC CE, and a third bit field that indicates whether a second UL TCI state is mapped to the codepoint in the MAC CE.

In one embodiment, at least one DL TCI state and at least one UL TCI state are mapped to each codepoint of the plurality of codepoints of the TCI field, and the information comprised in the MAC CE comprises, for each codepoint of the plurality of codepoints of the TCI field: a first bit field that indicates whether a second DL TCI state is mapped to the codepoint in the MAC CE and a second bit field that indicates whether a second UL TCI state is mapped to the codepoint in the MAC CE.

In one embodiment, at least one DL TCI state is mapped to each codepoint of the plurality of codepoints of the TCI field, and the information comprised in the MAC CE comprises, for each codepoint of the plurality of codepoints of the TCI field: a first bit field that indicates whether a first DL TCI state is mapped to the codepoint in the MAC CE, a second bit field that indicates whether a second DL TCI state is mapped to the codepoint in the MAC CE, a third bit field that indicates whether a first UL TCI state is mapped to the codepoint in the MAC CE, and a fourth bit field that indicates whether a second UL TCI state is mapped to the codepoint in the MAC CE.

Corresponding embodiments of a RAN node are also disclosed. In one embodiment, a RAN node is adapted to send, to a WCD, a MAC CE that comprises information that: (a) indicates a plurality of activated TCI states for the WCD comprising at least one DL TCI state and at least one UL TCI state and (b) maps each activated TCI state of the plurality of activated TCI states to one of a plurality of codepoints of a TCI field in a DCI.

In one embodiment, a RAN node comprises processing circuitry configured to cause the RAN node to send, to a WCD, a MAC CE that comprises information that: (a) indicates a plurality of activated TCI states for the WCD comprising at least one DL TCI state and at least one UL TCI state and (b) maps each activated TCI state of the plurality of activated TCI states to one of a plurality of codepoints of a TCI field in a DCI.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates New Radio (NR) time-domain structure with 15 kHz subcarrier spacing;

FIG. 2 illustrates a basic NR physical time-frequency resource grid, where only one Resource Block (RB) within a 14-symbol slot is shown;

FIG. 3 illustrates the Transmission Configuration Indicator (TCI) state information element as defined in Third Generation Partnership Project (3GPP) Technical Specification (TS) 38.331, NR; Radio Resource Control (RRC); Protocol Specification, V16.2.0 (10-2020);

FIG. 4 depicts a two-step procedure related to TCI state update;

FIG. 5 illustrates the structure of the Medium Access Control (MAC) Control Element (CE) for activating/deactivating TCI states for User Equipment (UE)-specific Physical Downlink Shared Channel (PDSCH) as defined in 3GPP TS 38.321, MAC protocol specification, V.16.2.0 (10-2020);

FIG. 6 illustrates an example of a Downlink Control Information (DCI) indication of a TCI state;

FIG. 7 illustrates one example of a cellular communications system in which embodiments of the present disclosure may be implemented

FIG. 8 illustrates a first example MAC CE in which DL TCI states to be activated are provided in Octets 2 to M of the MAC CE according to some embodiments of the present disclosure;

FIG. 9 illustrates a second example MAC CE according to some embodiments of the present disclosure;

FIG. 10 illustrates a first example MAC CE with 8-bit field representation according to some embodiments of the present disclosure;

FIG. 11 illustrates a second example MAC CE with 8-bit field representation according to some embodiments of the present disclosure;

FIG. 12 illustrates a third example MAC CE with 8-bit field representation according to some embodiments of the present disclosure;

FIG. 13 illustrates the operation of a Radio Access Node (RAN) node and a Wireless Communication Device (WCD) in accordance with at least some aspects of the embodiments described above;

FIG. 14 is a schematic block diagram of a RAN node according to some embodiments of the present disclosure;

FIG. 15 is a schematic block diagram that illustrates a virtualized embodiment of the RAN node according to some embodiments of the present disclosure;

FIG. 16 is a schematic block diagram of the RAN node according to some other embodiments of the present disclosure

FIG. 17 is a schematic block diagram of a wireless communication device according to some embodiments of the present disclosure

FIG. 18 is a schematic block diagram of the wireless communication device according to some other embodiments of the present disclosure;

FIG. 19 illustrates a communication system includes a telecommunication network, such as a 3GPP-type cellular network, according to some embodiments of the present disclosure;

FIG. 20 illustrates example implementations of the previously described UE, base station, and host computer according to some embodiments of the present disclosure;

FIG. 21 is a flowchart illustrating a method implemented in a communication system, in accordance with one embodiment;

FIG. 22 is a flowchart illustrating a method implemented in a communication system, in accordance with one embodiment;

FIG. 23 is a flowchart illustrating a method implemented in a communication system, in accordance with one embodiment; and

FIG. 24 is a flowchart illustrating a method implemented in a communication system, in accordance with one embodiment.

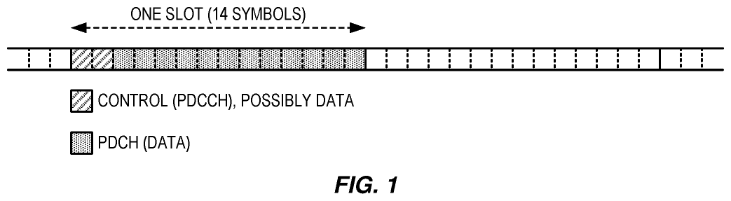

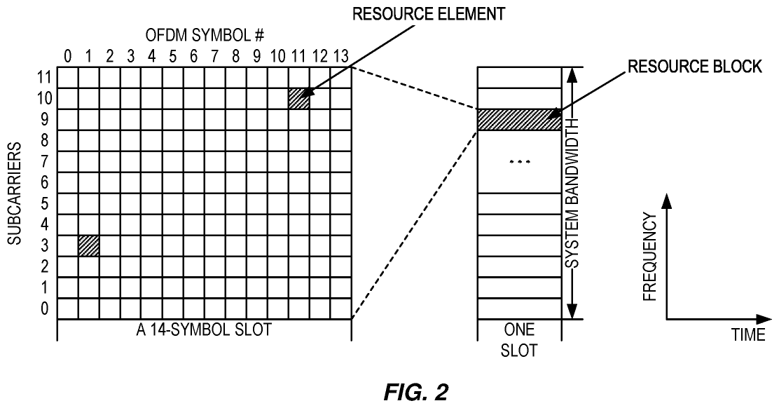

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” or “RAN node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

In 3GPP Rel-17, a new enhanced TCI state framework will be specified. Specifically, in 3GPP Technical Specification Group (TSG) RAN WG1 e-meeting RAN1 #103-e, it was agreed that the new TCI state framework should include a three stage TCI state indication (in a similar way as was described above for Physical Downlink Shared Channel (PDSCH)) for all or a subset of all downlink and/or uplink channels/signals. In the first stage, RRC is used to configure a pool of TCI states. In the second stage, one or more of the Radio Resource Control (RRC) configured TCI states are activated via Medium Access Control (MAC)-Control Element (CE) signaling. Finally, in the third stage, Downlink Control Information (DCI) signaling is used to select one of the TCI states that was activated via MAC-CE. The TCI states used for downlink (DL) and uplink (UL) channels/signals can either be taken from the same pool of TCI states or from separate pools of TCI states (i.e., from separate downlink TCI state and uplink TCI state pools). It is also possible that two separate lists of activated TCI states are used, one for downlink channels/signals and one for uplink channels/signals.

Some agreements from the RAN1 #103-e e-meeting is copied below:

There currently exist certain challenge(s). In NR Rel-17, it is agreed that downlink DCI is used to indicate a beam update (i.e., TCI state update). The TCI states will be activated by MAC CE and mapped to TCI field codepoints in downlink DCI. Furthermore, both downlink TCI states and uplink TCI states will be supported in New Radio (NR) Rel-17. An open problem is how MAC CE signals the activation and mapping of downlink and uplink TCI states to the codepoints of a downlink DCI.

Certain aspects of the present disclosure and their embodiments may provide solutions to the aforementioned or other challenges. Systems and methods are disclosed herein that provide a way to activate downlink and/or uplink TCI states for different DCI codepoints using a MAC CE. Embodiments of the present disclosure include various MAC CE designs that provide such a mapping.

Certain embodiments of the present disclosure may provide one or more of the following technical advantage(s). The proposed MAC CE signaling solutions provide efficient and flexible mechanisms to associate one or multiple DL and/or UL TCI state(s) associated with a codepoint of a TCI field in DCI. The proposed solution results in low signaling overhead for activating DL and/or UL TCI states to a UE.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell;” however, particularly with respect to 5G NR concepts, beams may be used instead of cells and, as such, it is important to note that the concepts described herein are equally applicable to both cells and beams.

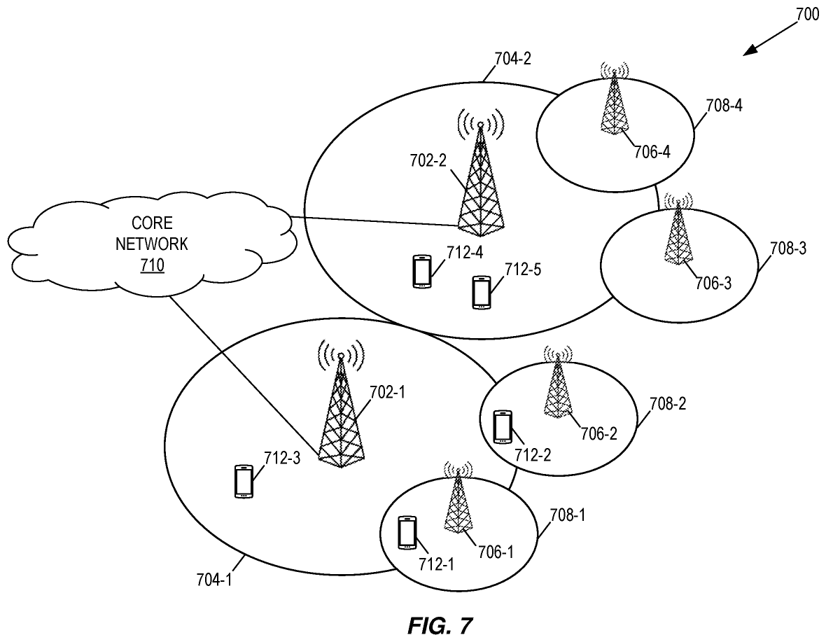

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC), however the embodiments disclosed herein are not limited thereto. In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

### I. General Embodiments

A UE is configured by a gNB with one or more of a list of DL TCI states and a list of UL TCI states. The TCI states in the list of DL TCI states are applicable to DL channels such as, e.g., Physical Downlink Control Channel (PDCCH) and PDSCH and DL reference signals such as, e.g., Channel State Information (CSI)-Reference Signal (RS). The TCI states in the list of UL TCI states are applicable to UL channels such as, e.g., PUCCH and Physical Uplink Shared Channel (PUSCH) and UL reference signals such as, e.g., Sounding Reference Signal (SRS).

In one embodiment, a single MAC CE is used to activate DL TCI states and/or UL TCI states. The MAC CE also maps the activated DL TCI states and/or the activated UL TCI states to a plurality of codepoints in a TCI field of a DCI. For instance, the DCI here may be a downlink DCI with format 1_1 or 1_2.

A particular codepoint, referred to as codepoint x, among the plurality of codepoints of the TCI field of the DCI is mapped via the MAC CE to both one or more activated DL TCI states and one or more activated UL TCI states. When the UE receives a DCI where the TCI field indicates the codepoint x, the UE can perform the following procedures:
The UE updates the DL TCI state(s) to be applied to DL reference signals (e.g., PDCCH/PDSCH DMRS or CSI-RS) to the activated DL TCI state(s) mapped to the codepoint x received in the TCI field of the DCI. For example, if the codepoint x is mapped to two DL TCI states, then the first DL TCI state corresponds to a first TRP, and the second DL TCI state corresponds to a second TRP.
The UE updates the UL TCI state(s) to be applied to UL channels (e.g., PUCCH/PUSCH) and/or UL reference signals (e.g., SRS) to the activated UL TCI state(s) mapped to the codepoint x received in the TCI field of the DCI. For example, if the codepoint x is mapped to two UL TCI states, then the first UL TCI state corresponds to a first TRP, and the second UL TCI state corresponds to a second TRP.

### I.A Mapping of Same Number of DL and UL TCI States to a Codepoint

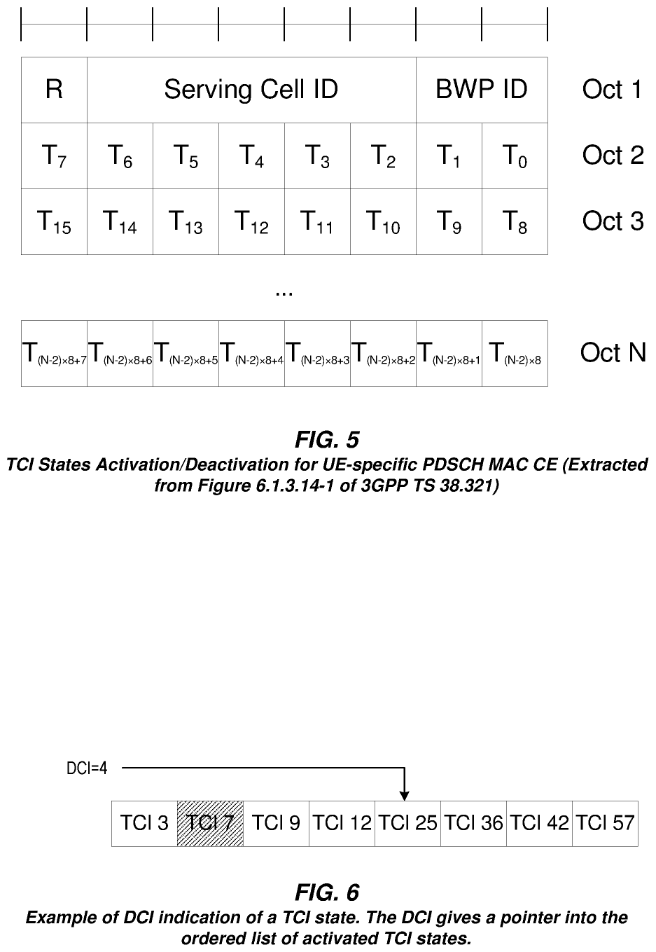

In one embodiment, in a single TRP case where a UE may receive DL channels/reference signals using a first beam corresponding to a first DL TCI state and transmit UL channels/reference signals using a second beam corresponding to a first UL TCI state, a codepoint x among the plurality of codepoints in the TCI field of the DCI is mapped via the MAC CE to one DL TCI state and one UL TCI state. For example, as described with regards to FIG. 5, the one DL TCI state and one UL TCI state may be mapped to the codepoint x that is the codepoint for one CC/DL BWP, a set of CCs/DL BWPs, one CC/UL BWP, a set of CCs/DL BWPs and CCs/UL BWPs, etc. To follow the previous example, if the codepoint x is the codepoint for a set of CCs/DL BWPs or a set of CCs/DL BWPs and CCs/UL BWPs, the DL and UL TCI states can be applied to each DL BWP in the set.

For the single-DCI based multi-TRP case, the DL channels/reference signals received using the first beam corresponding to the first DL TCI state may be transmitted from a first TRP, whereas the UL channels/reference signals transmitted using a second beam corresponding to a first UL TCI state may be transmitted towards a second TRP.

In another embodiment, in a case where a UE receives DL channels/reference signals from two TRPs in the DL and transmits UL channels/reference signals towards two TRPs in the UL, a codepoint x among the plurality of codepoints in the TCI field of the DCI is mapped via the MAC CE to two DL TCI states and two UL TCI states. Here, the two DL TCI states corresponds to two beams received from two TRPs in the DL, and the two UL TCI states corresponds to two beams transmitted towards two TRPs in the UL.

### I.B Mapping of Different Number of DL and UL TCI States to a Codepoint

In one embodiment, in a case where a UE receives DL channels/reference signals from two TRPs in the DL and transmits UL channels/reference signals towards a single TRP, a codepoint x among the plurality of codepoints in the TCI field of the DCI is mapped via the MAC CE to two DL TCI states and one UL TCI state. Here, the two DL TCI states correspond to two beams received from two TRPs in the DL, and the UL TCI state corresponds to a beam transmitted towards one TRP in the UL.

In another embodiment, in a case where a UE receives DL channels/reference signals from one TRP in the DL and transmits UL channels/reference signals towards two TRPs in the UL, a codepoint x among the plurality of codepoints in the TCI field of the DCI is mapped via the MAC CE to one DL TCI state and two UL TCI states. Here, the one DL TCI state corresponds to one beam received from one TRP in the DL, and the two UL TCI states corresponds to two beams transmitted towards two TRPs in the UL.

### I.C Mapping of Either DL TCI State(s) or UL TCI State(s) to a Codepoint

In some cases, it may be desirable to only update the DL TCI states to be applied to DL channels and/or DL reference signals. In these cases, in one embodiment, a codepoint x among the plurality of codepoints in the TCI field of the DCI is mapped via the MAC CE to either one or two DL TCI states, and no UL TCI state. When the UE receives a DCI where the TCI field indicates the codepoint x, the UE updates the one or two DL TCI state(s) to be applied to DL channels and/or DL reference signals.

In some other cases, it may be desirable to only update the UL TCI states to be applied to UL channels and/or DL reference signals. In these cases, in one embodiment, a codepoint x among the plurality of codepoints in the TCI field of the DCI is mapped via the MAC CE to either one or two UL TCI states, and no DL TCI state. When the UE receives a DCI where the TCI field indicates the codepoint x, the UE updates the one or two UL TCI state(s) to be applied to UL channels and/or UL reference signals.

### I.D Indication Bit Fields in MAC CE

In the one embodiment, the plurality of codepoints in the TCI field of the DCI may contain different mappings to DL and UL TCI states wherein:
a subset of the codepoints may be mapped to the same number of DL and UL TCI states as previously described in Section I.A,
a subset of the codepoints may be mapped to different number of DL and UL TCI states as previously described in Section I.B, and/or
a subset of the codepoints may be mapped to either DL TCI state(s) or UL TCI state(s) as previously described in Section I.C.

Hence, to support different mappings to different codepoints, the MAC CE needs to contain different bit fields that indicate how many and which DL TCI state(s) and/or UL TCI state(s) are mapped to each codepoint. In one embodiment, for each codepoint, a plurality of binary fields may be present in the MAC CE wherein:
each bit in a first bit field indicates whether a given codepoint is mapped to a first DL TCI state (e.g., N bits for N codepoints where each one of the bits in the first bit field indicates whether a respective one of the codepoints is mapped to the first DL TCI state),
each bit in a second bit field indicates whether the given codepoint is mapped to a second DL TCI state (e.g., N bits for N codepoints where each one of the bits in the second bit field indicates whether a respective one of the codepoints is mapped to the second DL TCI state),
each bit in a third bit field indicates whether the given codepoint is mapped to a first UL TCI state (e.g., N bits for N codepoints where each one of the bits in the third bit field indicates whether a respective one of the codepoints is mapped to the first UL TCI state), and/or
each bit in a fourth bit field indicates whether the given codepoint is mapped to a second UL TCI state (e.g., N bits for N codepoints where each one of the bits in the fourth bit field indicates whether a respective one of the codepoints is mapped to the second UL TCI state).

In some embodiments, only a subset of the above bit fields may be present in the MAC CE. In one example embodiment, a given codepoint is always mapped to a first DL TCI state. Whether the given codepoint is mapped to a second DL TCI state, a first UL TCI state, and/or a second UL TCI state is given by three (or N) different bit fields in the MAC CE.

In another embodiment, the abovementioned fields may be predetermined in 3GPP specifications, or be configured via RRC signaling. In this embodiment, the above binary fields do not need to be included as part of the MAC CE. The following are some examples of this embodiment:
Example 1: the gNB can RRC configure the UE with an indication that indicates a given codepoint is only mapped to a first DL TCI state and no UL TCI state, and the MAC CE provides which DL TCI state is mapped to the given codepoint.
Example 2: the gNB can RRC configure the UE with an indication that indicates a given codepoint is mapped to two DL TCI states and no UL TCI state, and the MAC CE provides which two DL TCI states are mapped to the given codepoint.
Example 3: the gNB can RRC configure the UE with an indication that indicates a given codepoint is only mapped to a first UL TCI state and no DL TCI state, and the MAC CE provides which UL TCI state is mapped to the given codepoint.
Example 4: the gNB can RRC configure the UE with an indication that indicates a given codepoint is mapped to two UL TCI states and no DL TCI state, and the MAC CE provides which two UL TCI states are mapped to the given codepoint.
Example 5: the gNB can RRC configure the UE with an indication that indicates a given codepoint is mapped to a first DL TCI state and a first UL TCI state, and the MAC CE provides which DL TCI state and UL TCI state are mapped to the given codepoint.
Example 6: the gNB can RRC configure the UE with an indication that indicates a given codepoint is mapped to two DL TCI states and a first UL TCI state, and the MAC CE provides which two DL TCI states and UL TCI state are mapped to the given codepoint.
Example 7: the gNB can RRC configure the UE with an indication that indicates a given codepoint is mapped to a first DL TCI state and two UL TCI states, and the MAC CE provides which DL TCI state and two UL TCI states are mapped to the given codepoint.
Example 8: the gNB can RRC configure the UE with an indication that indicates a given codepoint is mapped to two DL TCI states and two UL TCI states, and the MAC CE provides which two DL TCI states and two UL TCI states are mapped to the given codepoint.

An example MAC CE that can be used for embodiments of the present disclosure is as follows.

| CORESETPoolId | Serving cell ID | BWP ID bits | OCT 1 |
|---|---|---|---|
| (1 bit) | (5 bits) | (2) | |

| | |
|---|---|
| DL TCI state ID_{0, 1} (8 bits) | OCT 2 |
| DL TCI state ID_{0, 2} (8 bits) | OCT 3 |
| UL TCI state ID_{n, 1} (8 bits) | OCT 4 |
| UL TCI state ID_{n, 0} (8 bits) | OCT 5 |

In this example, the MAC CE has a fixed size. The first field in the first octet may represent the CORESETPoolindex in order the UE to know how to interpret the TCI states. That is, if the DCI was sent to the UE via PDCCH mapped to CORESETPoolIndex=1, the UE uses the mapping of the TCI states received earlier by the UE by a MAC CE which had this field set to ‘1’. Similarly, if the same DCI was received via PDCCH that is mapped to CORESETPoolIndex=0, the UE uses the mapping of the TCI states received earlier by the UE by a MAC CE which had this field set to ‘0’. In this way, the same DCI codepoints may have two different mappings depending via which TRP the PDCCH(DCI) was sent. The advantage of the fixed size MAC CE is that 8 bits may be used for the TCI state ID.

### I.E Mapping of Activated TCI States to CORESETs

When there is a single DL TCI state associated with a codepoint in the MAC CE and the codepoint is indicated in a DL DCI, in one embodiment, the corresponding DL TCI state is applied to (or activated for) all CORESETs configured to the UE. In another embodiment, the corresponding DL TCI state is applied to a subset of CORESETs, e.g., CORESETS with even (or odd) numbered CORESET indices.

When there are two DL TCI states associated with a codepoint in the MAC CE and the codepoint is indicated in a DL DCI and if only one CORESET is configured for the UE, in one embodiment, the first of the two TCI states is applied to the CORESET. In another embodiment, the CORESET is activated with both of the two TCI states. This corresponds to sending a same DCI over two TRPs in the same time and frequency resource.

When there are two DL TCI states associated with a codepoint in the MAC CE and the codepoint is indicated in a DL DCI and if more than one CORESET are configured for the UE, the mapping between the two activated TCI states and the CORESETs follows a predefined pattern. For example, the first of the two TCI states may be mapped to CORESETs with even (or odd) numbered CORESET indices, and the second of the two TCI states may be mapped to the remaining CORESETs. In a further embodiment, all the CORESETs are activated with both of the two TCI states. In yet another embodiment, if two CORESETs are linked via two linked search space sets, the two CORESETs are activated with the two TCI states, respectively.

### I.F Mapping of Activated TCI States to UL Channels and Signals

In one embodiment, when there is a single UL TCI state associated with a codepoint in the MAC CE and the codepoint is indicated in a DL DCI, if a PUCCH resource was activated with a single UL TCI state, the UL TCI state is updated with the new UL TCI state. If a PUCCH resource was activated with two UL TCI states, in one embodiment, the first (or the second) TCI state is updated with the new UL TCI state.

For UL transmission to two TRPs, two SRS resource sets need to be configured for both codebook and non-codebook based PUSCH transmissions. In one embodiment, when there are two UL TCI states associated with a codepoint in the MAC CE and the codepoint is indicated in a DL DCI, the first of the two TCI states may be mapped to SRS resources in the first SRS resource set with even (or odd) numbered SRS resource set index and the second of the two TCI states may be mapped to SRS resources in the other SRS resource set.

### II. First Detailed Embodiments

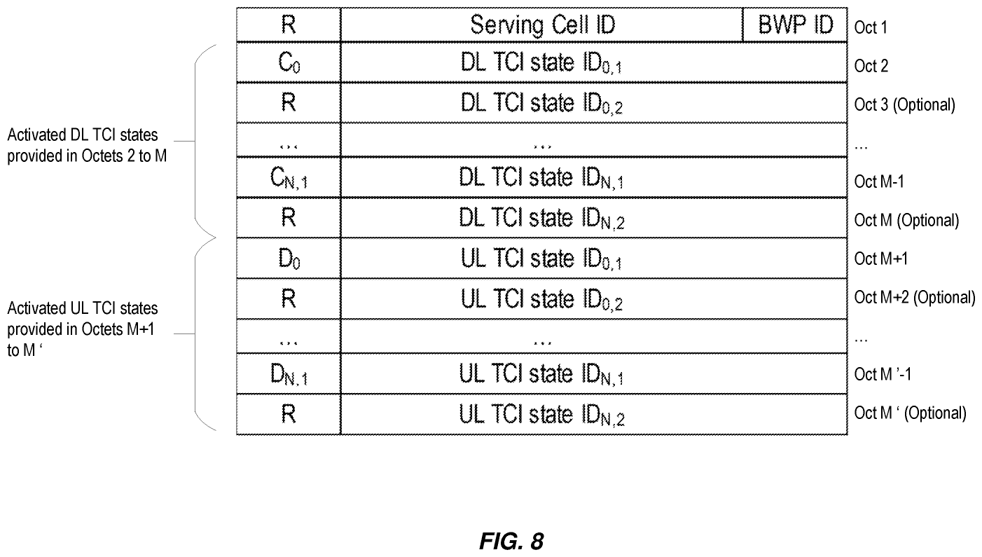

In this embodiment, in one MAC CE, a network node (e.g., a base station 702 such as, e.g., a gNB) can separately indicate the activated DL TCI state(s) and UL TCI state(s). The activated DL TCI state(s) and UL TCI state(s) are mapped to the codepoints of the TCI field in a DCI (e.g., a DL DCI with format 1_1 or 1_2). FIG. 6 illustrates an example of a MAC CE that separately indicates the activated DL TCI state(s) and UL TCI state(s) according to some embodiments of the present disclosure. Specifically, in this embodiment, each codepoint in the TCI field of the DCI is mapped to at least one DL TCI state and at least one UL TCI state. Whether a codepoint is mapped to another DL TCI state is indicated by the binary field ‘Cⱼ.’ Whether a codepoint is mapped to another UL TCI state is indicated by the binary field ‘Dⱼ.’
FIG. 8 illustrates a first example MAC CE in which DL TCI states to be activated are provided in Octets 2 to M of the MAC CE according to some embodiments of the present disclosure. Specifically, the first DL TCI state mapped to the j^{th} codepoint in the TCI field of the DCI is given by the ‘DL TCI state ID_{j,1}’. The second DL TCI state mapped to the j^{th} codepoint in the TCI field of the DCI is given by the DL TCI state ID_{j,2}′, and so on. The field in the MAC CE indicates if another DL TCI state will be associated with the j^{th} codepoint in the TCI field of the DCI. If field ‘Cⱼ’ is set to 1, then another DL TCI state will be mapped to the j^{th} codepoint in the TCI field of the DCI. Otherwise, another DL TCI state will not be mapped to the j^{th} codepoint in the TCI field of the DCI, in which case the subsequent octet will describe either the (j+1)^{th} codepoint in the TCI field of the DCI, or the first UL TCI state of the first codepoint in the TCI field of the DCI. The number of codepoints in the TCI field of the DCI in FIG. 8 is given by N.
In the same MAC CE of the example in FIG. 8, the UL TCI states to be activated are provided in Octets M+1 to M′. The first UL TCI state mapped to the j^{th} codepoint in the TCI field of the DCI is given by the ‘UL TCI state ID_{j,1}’. The second UL TCI state mapped to the j^{th} codepoint in the TCI field of the DCI is given by the ‘UL TCI state ID_{j,2}’, and so on. The field ‘Dⱼ’ in the MAC CE indicates if another UL TCI state will be associated with the j^{th} codepoint in the TCI field of the DCI. If field ‘Dⱼ’ is set to 1, then another UL TCI state will be mapped to the j^{th} codepoint in the TCI field of the DCI. Otherwise, another UL TCI state will not be mapped to the j^{th} codepoint in the TCI field of the DCI, in which case the subsequent octet will describe the (j+1)^{th} codepoint in the TCI field of the DCI.

In some embodiments, in order for the UE to be able to decode the MAC CE, the structure needs to be known. One option is to hard code or configure (e.g., configure via RRC) the number of potential pairs of DL or UL TCI states and use the length field of the MAC CE. In one example, the number of DL TCI states and the number of UL TCI states per each codepoint may be configured (e.g., configured via RRC). From this configuration information, the UE will know the number of octets needed for signaling the DL TCI states and UL TCI states (i.e., the values M and M′ can be known from this configuration).

In some other examples, the MAC CE can be defined such that it always includes both UL and DL TCI states, and the UE is configured (e.g., RRC configured) on the number of the DL and UL pairs, respectively. Another option is that UE uses the TCI field size in DCI and only the number of DL and UL TCI states is configured (e.g., RRC configured). The configuration (e.g., RRC configuration) may include the number of TCI state codepoints in the TCI field in DCI. This may be configured (e.g., via RRC) for both DL and UL or it may be configured jointly as one value that is applicable to both DL and UL. Then, the UE knows from ‘Cⱼ’ field whether the first DL TCI state follows with another DL TCI state that is a pair to the first TCI state. Then, UE knows if the next TCI state is still DL TCI state followed by a potential pair, or it is an UL TCI state followed by a potential pair (known from ‘Dⱼ’ field). Alternatively, the R field in the first octet may be used to inform the UE whether the MAC CE includes both DL and UL TCI states or only the DL TCI states.

The above embodiments can be extended to Multi-DCI based Multi-TRP scenario. For instance, the R field in the first octet of FIG. 8 may represent the CORESETPoolindex in order for the UE to know how to interpret the TCI states. That is, if the R field is set to ‘1’, then the TCI states activation and mappings received in the MAC CE is applied DL/UL channels/reference signals associated with CORESETPoolIndex=1. Similarly, if the R field is set to ‘0’, then the TCI states activation and mappings received in the MAC CE is applied DL/UL channels/reference signals associated with CORESETPoolIndex=0. In this way, the same TCI field codepoints may have two different TCI state to codepoint mappings depending on which TRP (e.g., CORESETPoolIndex) the PDCCH(DCI) was sent from. For reference signals that are not directly related to CORESETPoolIndex, a mapping to one of the CORESETPoolIndex values may be added.

### III. Second Detailed Embodiments

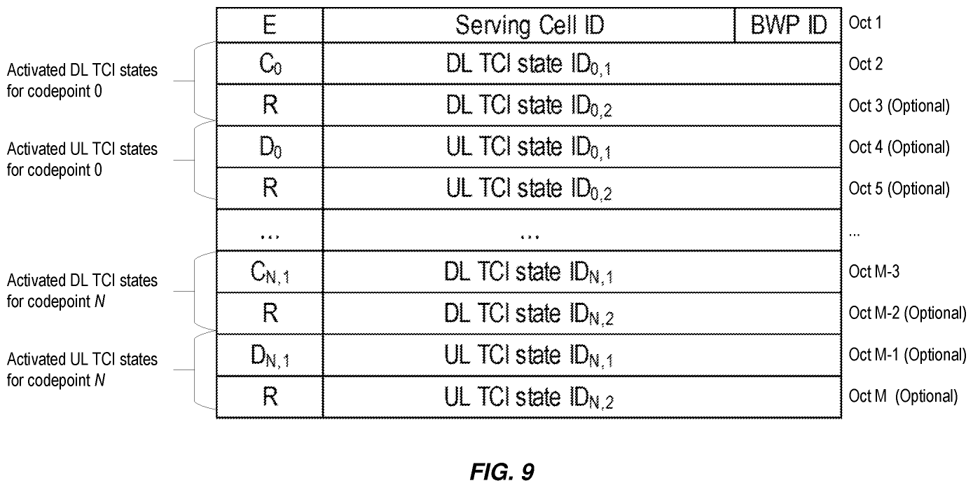

FIG. 9 illustrates a second example MAC CE according to some embodiments of the present disclosure. Specifically, in these embodiments, each codepoint in the TCI field of the DCI may be mapped to at least one DL TCI state. Whether a codepoint is mapped to a second DL TCI state is indicated by the binary field ‘Cⱼ.’ Whether the codepoints are mapped to a first UL TCI state is indicated by the field ‘E.’ Whether a codepoint is mapped to a second UL TCI state is indicated by the binary field ‘Dⱼ.’
In the example of FIG. 9, the first DL TCI state mapped to the j^{th} codepoint in the TCI field of the DCI is given by the ‘DL TCI state ID_{j,1}’. The second DL TCI state mapped to the j^{th} codepoint in the TCI field of the DCI is given by the ‘DL TCI state ID_{j,2}’. The field ‘Cⱼ’ in the MAC CE indicates if a second DL TCI state will be associated with the j^{th} codepoint in the TCI field of the DCI. If field ‘Cⱼ’ is set to 1, then a second DL TCI state will be mapped to the j^{th} codepoint in the TCI field of the DCI. Otherwise, a second DL TCI state will not be mapped to the j^{th} codepoint in the TCI field of the DCI. The number of codepoints in the TCI field of the DCI in FIG. 9 is given by N.
In the same MAC CE of the example in FIG. 9, the first UL TCI state mapped to the j^{th} codepoint in the TCI field of the DCI is given by the ‘UL TCI state ID_{j,1}′. The second UL TCI state mapped to the j^{th} codepoint in the TCI field of the DCI is given by the ‘UL TCI state ID_{j,2}’. The field ‘E’ in the MAC CE indicates if first UL TCI states will be associated with each of the codepoints in the TCI field of the DCI. If field ‘E’ is set to 1, then first UL TCI states will be mapped to the codepoints in the TCI field of the DCI. Otherwise, first UL TCI states will not be mapped to the codepoints in the TCI field of the DCI. The field ‘Dⱼ’ in the MAC CE indicates if a second UL TCI state will be associated with the j^{th} codepoint in the TCI field of the DCI. If field ‘Dⱼ’ is set to 1, then a second UL TCI state will be mapped to the j^{th} codepoint in the TCI field of the DCI. Otherwise, a second UL TCI state will not be mapped to the j^{th} codepoint in the TCI field of the DCI.

### IV. Third Detailed Embodiment

In some cases, the number of DL or UL TCI states configured to the UE may be extended to 256 in NR Rel-17. This is because inter-cell multi-TRP will be introduced in NR Rel-17, as such to support TCI states associated with a reference signal in the neighbor cell, the number of DL or UL TCI states may need to be increased. This hence means that each DL TCI state ID or UL TCI state ID needs to be represented by an 8-bit field.

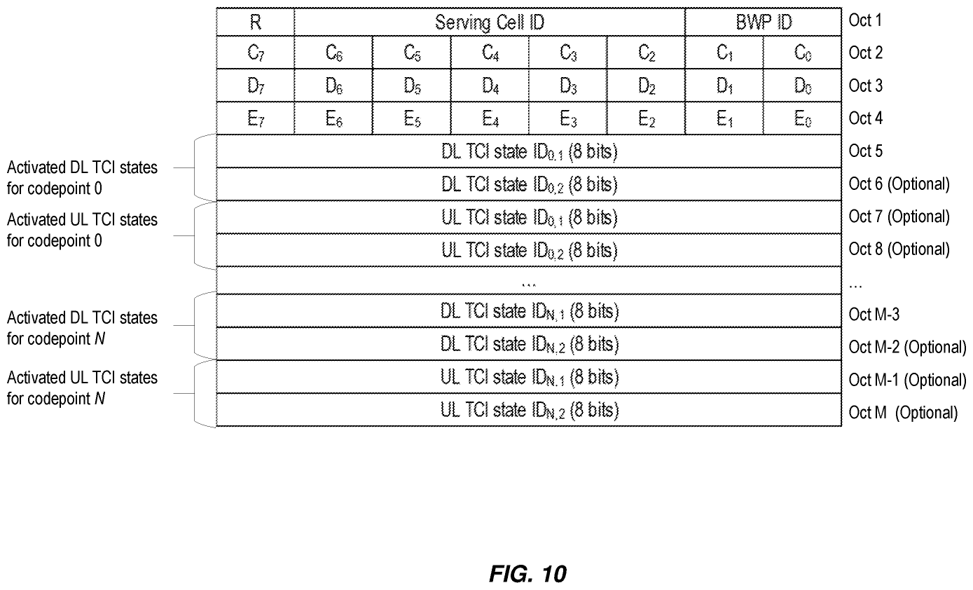

FIG. 10 illustrates a first example MAC CE with 8-bit field representation according to some embodiments of the present disclosure. Specifically, in this example,
the field ‘Cⱼ’ in the MAC CE indicates if a second DL TCI state will be associated with the j^{th} codepoint in the TCI field of the DCI. If field ‘Cⱼ’ is set to 1, then a second DL TCI state will be mapped to the j^{th} codepoint in the TCI field of the DCI. Otherwise, a second DL TCI state will not be mapped to the j^{th} codepoint in the TCI field of the DCI.
the field ‘Dⱼ’ in the MAC CE indicates if a first UL TCI state will be associated with the j^{th} codepoint in the TCI field of the DCI. If field ‘Dⱼ’ is set to 1, then a first UL TCI state will be mapped to the j^{th} codepoint in the TCI field of the DCI. Otherwise, a first UL TCI state will not be mapped to the j^{th} codepoint in the TCI field of the DCI.
the field ‘Eⱼ’ in the MAC CE indicates if a second UL TCI state will be associated with the j^{th} codepoint in the TCI field of the DCI. If field ‘Eⱼ’ is set to 1, then a second UL TCI state will be mapped to the j^{th} codepoint in the TCI field of the DCI. Otherwise, a second UL TCI state will not be mapped to the j^{th} codepoint in the TCI field of the DCI.

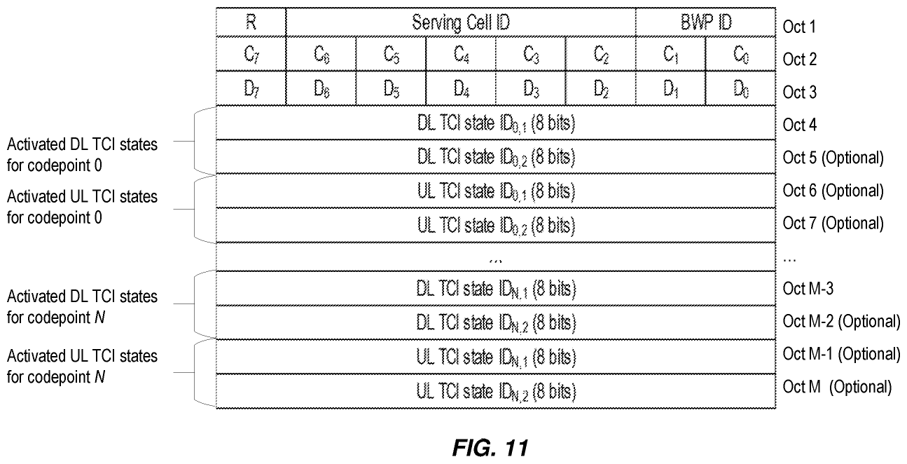

FIG. 11 illustrates a second example MAC CE with 8-bit field representation according to some embodiments of the present disclosure. Specifically, in this example,
the field ‘Cⱼ’ in the MAC CE indicates if a second DL TCI state will be associated with the j^{th} codepoint in the TCI field of the DCI. If field ‘Cⱼ’ is set to 1, then a second DL TCI state will be mapped to the j^{th} codepoint in the TCI field of the DCI. Otherwise, a second DL TCI state will not be mapped to the j^{th} codepoint in the TCI field of the DCI.
Whether the codepoints are mapped to a first UL TCI state is indicated by the field ‘E.’
the field ‘Dⱼ’ in the MAC CE indicates if a second UL TCI state will be associated with the j^{th} codepoint in the TCI field of the DCI. If field ‘Dⱼ’ is set to 1, then a second UL TCI state will be mapped to the j^{th} codepoint in the TCI field of the DCI. Otherwise, a second UL TCI state will not be mapped to the j^{th} codepoint in the TCI field of the DCI.

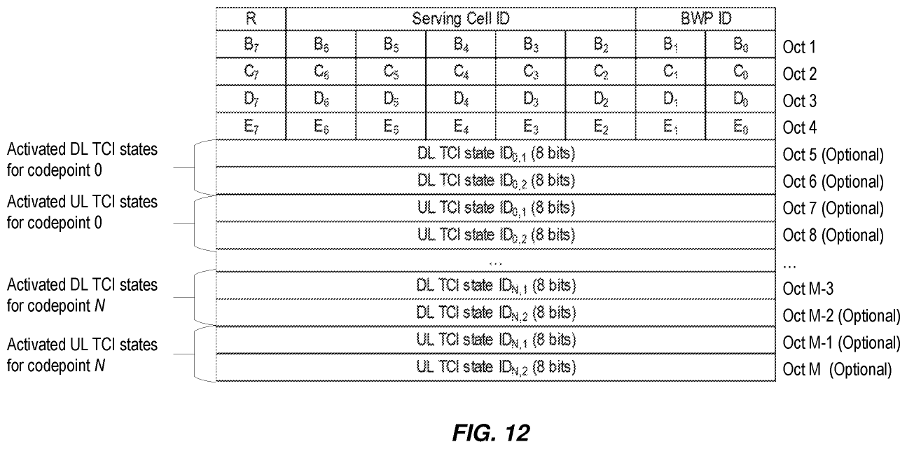

FIG. 12 illustrates a third example MAC CE with 8-bit field representation according to some embodiments of the present disclosure. Specifically, in this example,
the field ‘Bⱼ’ in the MAC CE indicates if a first DL TCI state will be associated with the j^{th} codepoint in the TCI field of the DCI. If field is set to 1, then a first DL TCI state will be mapped to the j^{th} codepoint in the TCI field of the DCI. Otherwise, a first DL TCI state will not be mapped to the j^{th} codepoint in the TCI field of the DCI.
the field ‘Cⱼ’ in the MAC CE indicates if a second DL TCI state will be associated with the j^{th} codepoint in the TCI field of the DCI. If field ‘Cⱼ’ is set to 1, then a second DL TCI state will be mapped to the j^{th} codepoint in the TCI field of the DCI. Otherwise, a second DL TCI state will not be mapped to the j^{th} codepoint in the TCI field of the DCI.
the field ‘Dⱼ’ in the MAC CE indicates if a first UL TCI state will be associated with the j^{th} codepoint in the TCI field of the DCI. If field ‘Dⱼ’ is set to 1, then a first UL TCI state will be mapped to the j^{th} codepoint in the TCI field of the DCI. Otherwise, a first UL TCI state will not be mapped to the j^{th} codepoint in the TCI field of the DCI.
the field ‘Eⱼ’ in the MAC CE indicates if a second UL TCI state will be associated with the j^{th} codepoint in the TCI field of the DCI. If field ‘Eⱼ’ is set to 1, then a second UL TCI state will be mapped to the j^{th} codepoint in the TCI field of the DCI. Otherwise, a second UL TCI state will not be mapped to the j^{th} codepoint in the TCI field of the DCI.

An alternative MAC CE design that allows more than 7 bits also for the flexible size MAC CE can be described as follows. The max 8 bits in the octet 2 may be used to explicitly describe the structure of the following octets. These options may be configured (e.g., RRC configured) or hard coded, e.g., in 3GPP TS 38.321. For example, the bit length of the TCI state fields, possibly UL and DL separately, the number of pairs, which UL/DL TCI state is expected to have a pair and so on. There are 256 codepoints represented by the 8 bits. The UL/DL TCI state field length options could be, e.g., 7, 8, 9, or 10 bits. One option is to use two first bits to represent DL TCI state field length and two following bits to represent the UL TCI state field length. Then one can use 4 following bits to represent the number of pairs. If more than 4 bits are needed, the following octet may be used to describe the combination of UL/DL TCI states given in this MAC CE.

### V. Example Procedure and Additional Description

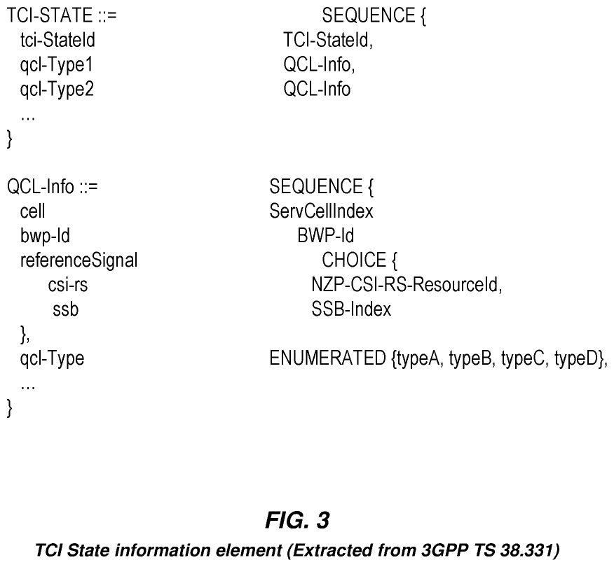

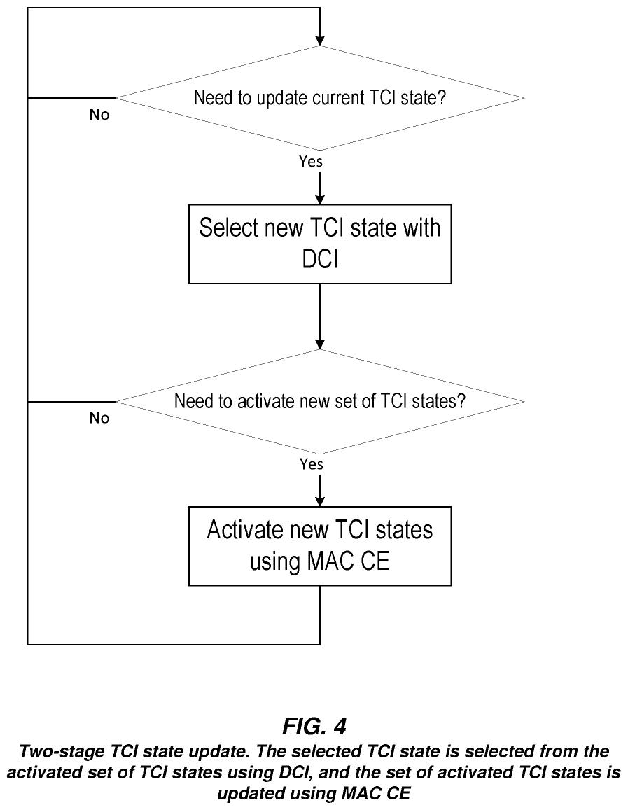

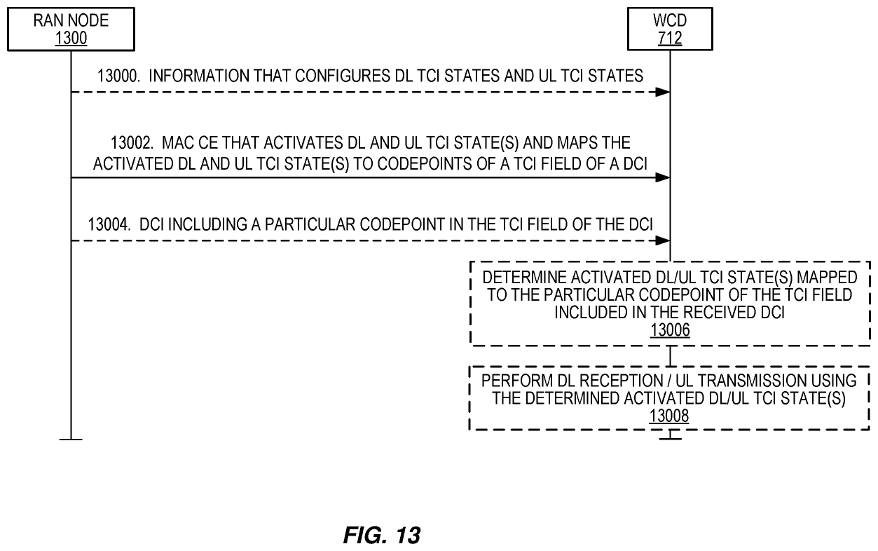

FIG. 13 illustrates the operation of a RAN node 1300 and a wireless communication device (WCD) 712 in accordance with at least some aspects of the embodiments described above. Optional steps are represented by dashed lines/boxes. The RAN node 1300 may be the base station 702 or a network node that implements part of the functionality of the base station 702 (e.g., a gNB-CU or gNB-DU). As illustrated, the RAN node 1300 sends (e.g., transmits), to the WCD 712, information that configures DL and UL TCI states for the WCD 712 (step 13000). In one embodiment, this information configures a list of DL TCI states for the WCD 712 and a (separate) list of UL TCI states for the WCD 712. In one embodiment, the information is sent to the WCD 712 is an RRC TCI State Configuration information element such as or similar to, e.g., that shown in FIG. 3. The number of DL TCI states configured for the WCD 712 and the number of UL TCI states configured for the WCD 712 are, in one embodiment, up to a configured or predefined maximum number of configured TCI states (e.g., 128 or 256).

The RAN node 1300 sends a MAC CE (e.g., a single MAC CE) to the WCD 712 that: (a) activates one or more of the configured DL TCI states, activates one or more of the configured UL TCI states, or both activates one or more of the configured DL TCI states and activates one or more of the configured UL TCI states and (b) indicates mappings between the activated DL/UL TCI states and codepoints of a TCI field of a DCI (e.g., for a particular DCI format such as, e.g., DCI format 1_1 or 1_2 in 3GPP NR) (step 13002). The MAC CE may be in accordance with any of the embodiments described above. While the details of all of those embodiments are not repeated here, it is to be understood that the details provided above are applicable the MAC CE of step 13002 as if all of those details were repeated here. For example, in one embodiment, the MAC CE maps at least one codepoint of the TCI field of a DCI to a first number of activated DL TCI states and a second number of activated UL TCI states, where the first and second number may be the same number or different numbers, as described above. As another example, in one embodiment, the MAC CE maps at least one codepoint of the TCI field of a DCI to either one or more activated DL TCI states or one or more activated UL TCI states. As yet another example, the MAC CE may map each of a first subset of the codepoints of the TCI field of a DCI to an equal number of activated DL and UL TCI states, and/or each of a second subset of the codepoints of the TCI field of the DCI to different numbers of activated DL and UL TCI states, and/or each of a third subset of the codepoints of the TCI field of a DCI to either one or more DL TCI states or one or more UL TCI states. In one embodiment, the MAC CE includes indication bit fields as described above in Section I.D. In some embodiments, the activated TCI states are mapped to CORESETs in accordance with Section I.E above. In some embodiments, the activated TCI states are mapped to UL channels and signals in accordance with Section I.F above. In another embodiment, the MAC CE is in accordance with any of the first detailed embodiments described in Section II above. In another embodiment, the MAC CE is in accordance with any of the second detailed embodiments described in Section III above. In another embodiment, the MAC CE is in accordance with any of the third detailed embodiments described in Section IV above.

The WCD 712 receives a DCI (in a PDCCH) from, in this example, the RAN node 1300 (step 13004). The DCI includes a TCI field set to a particular codepoint. The WCD 712 determines the activated DL/UL TCI state(s) to use for downlink reception or uplink transmission of the scheduled downlink transmission or uplink transmission based on the mapping between the particular codepoint of the TCI field in the received DCI and the respective activated DL/UL TCI state(s), as indicated by the MAC CE received in step 13002 (step 13006). The WCD 712 performs downlink reception or uplink transmission in accordance with the determined DL/UL TCI state(s) (step 13008).

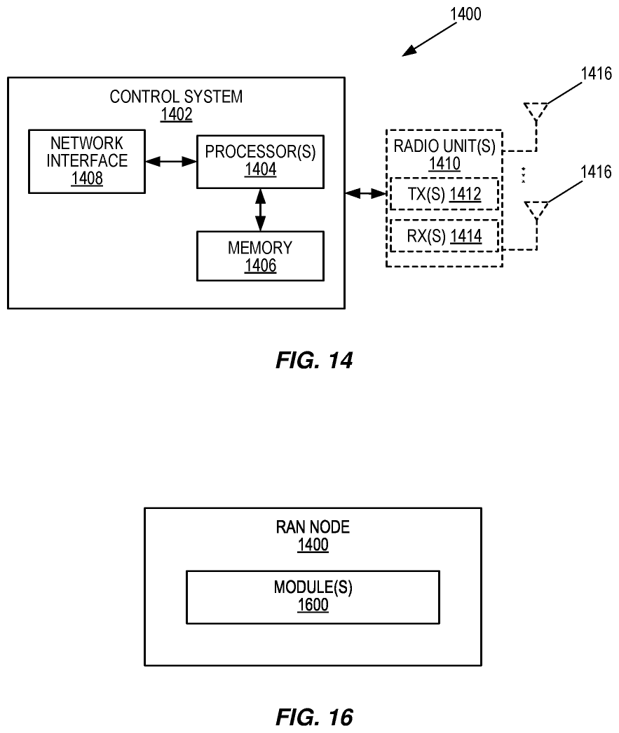

FIG. 14 is a schematic block diagram of a RAN node 1400 according to some embodiments of the present disclosure. Optional features are represented by dashed boxes. The RAN node 1400 may be, for example, the RAN node 1300 or gNB described herein. As illustrated, the RAN node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the RAN node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of the RAN node 1400 as described herein (e.g., one or more functions of a RAN node such as, e.g., the RAN node 1300 described herein). In some embodiments, the function(s) are implemented in software that is stored, e.g., in the memory 1406 and executed by the one or more processors 1404.

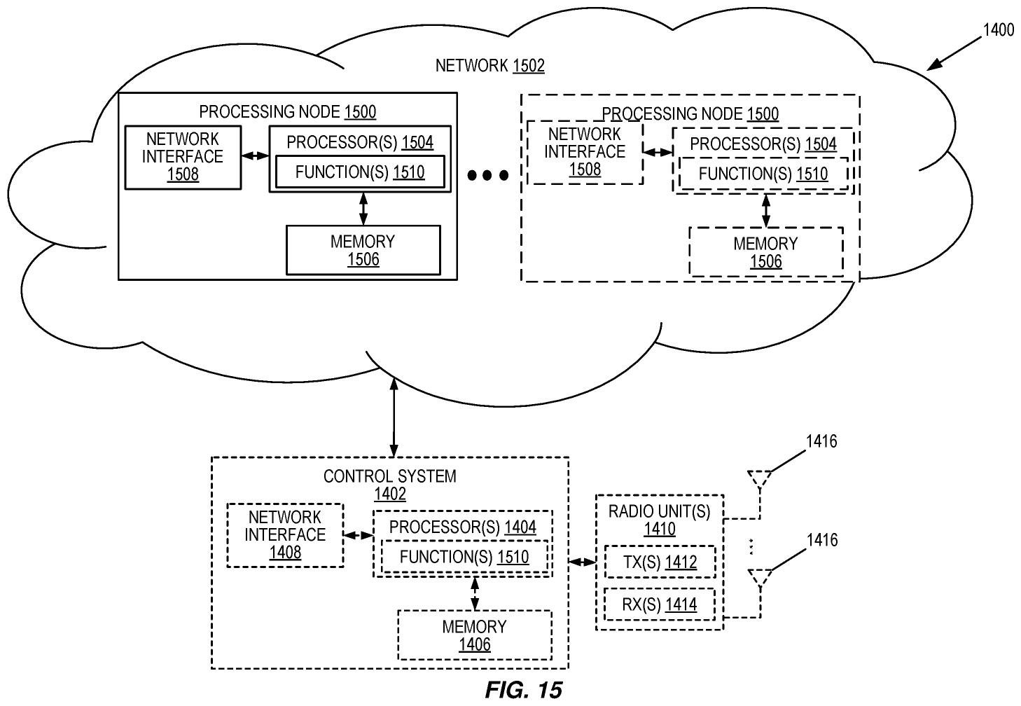

FIG. 15 is a schematic block diagram that illustrates a virtualized embodiment of the RAN node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” RAN node is an implementation of the RAN node 1400 in which at least a portion of the functionality of the RAN node 1400 is implemented as a virtual component(s) (e.g., via a virtual machine(s) executing on a physical processing node(s) in a network(s)). As illustrated, in this example, the RAN node 1400 may include the control system 1402 and/or the one or more radio units 1410, as described above. The control system 1402 may be connected to the radio unit(s) 1410 via, for example, an optical cable or the like. The RAN node 1400 includes one or more processing nodes 1500 coupled to or included as part of a network(s) 1502. If present, the control system 1402 or the radio unit(s) are connected to the processing node(s) 1500 via the network 1502. Each processing node 1500 includes one or more processors 1504 (e.g., CPUs, ASICs, FPGAs, and/or the like), memory 1506, and a network interface 1508.

In this example, functions 1510 of the RAN node 1400 described herein (e.g., one or more functions of a RAN node such as, e.g., the RAN node 1300 described herein) are implemented at the one or more processing nodes 1500 or distributed across the one or more processing nodes 1500 and the control system 1402 and/or the radio unit(s) 1410 in any desired manner. In some particular embodiments, some or all of the functions 1510 of the RAN node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of RAN node 1400 or a node (e.g., a processing node 1500) implementing one or more of the functions 1510 of the RAN node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the RAN node 1400 according to some other embodiments of the present disclosure. The RAN node 1400 includes one or more modules 1600, each of which is implemented in software. The module(s) 1600 provide the functionality of the RAN node 1400 described herein (e.g., one or more functions of a RAN node such as, e.g., the RAN node 1300 described herein). This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

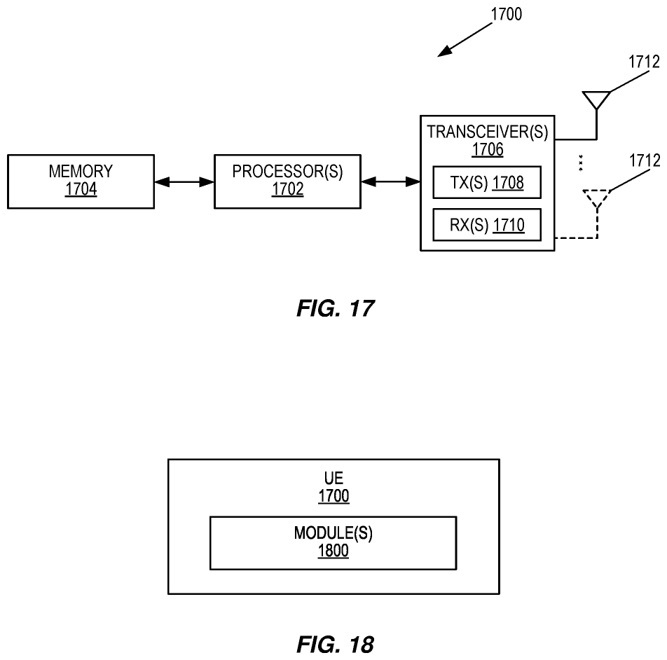

FIG. 17 is a schematic block diagram of a wireless communication device 1700 according to some embodiments of the present disclosure. The wireless communication device 1700 may be the WCD 712 or UE as described herein. As illustrated, the wireless communication device 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the wireless communication device 1700 described above (e.g., one or more functions of the WCD 712 or UE described herein) may be fully or partially implemented in software that is, e.g., stored in the memory 1704 and executed by the processor(s) 1702. Note that the wireless communication device 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the wireless communication device 1700 and/or allowing output of information from the wireless communication device 1700), a power supply (e.g., a battery and associated power circuitry), etc.

In some embodiments, a computer program including instructions which, when executed by at least one processor, causes the at least one processor to carry out the functionality of the wireless communication device 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the wireless communication device 1700 according to some other embodiments of the present disclosure. The wireless communication device 1700 includes one or more modules 1800, each of which is implemented in software. The module(s) 1800 provide the functionality of the wireless communication device 1700 described herein (e.g., one or more functions of the WCD 712 or UE described herein).

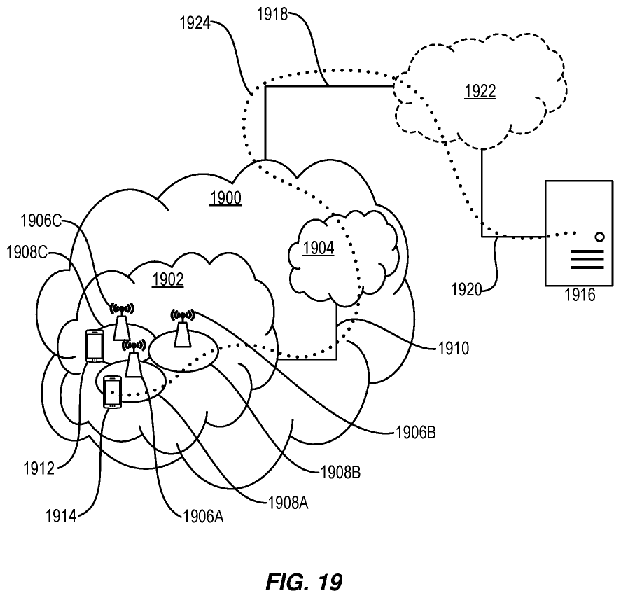

With reference to FIG. 19, in accordance with an embodiment, a communication system includes a telecommunication network 1900, such as a 3GPP-type cellular network, which comprises an access network 1902, such as a RAN, and a core network 1904. The access network 1902 comprises a plurality of base stations 1906A, 1906B, 1906C, such as Node Bs, eNBs, gNBs, or other types of wireless Access Points (APs), each defining a corresponding coverage area 1908A, 1908B, 1908C. Each base station 1906A, 1906B, 1906C is connectable to the core network 1904 over a wired or wireless connection 1910. A first UE 1912 located in coverage area 1908C is configured to wirelessly connect to, or be paged by, the corresponding base station 1906C. A second UE 1914 in coverage area 1908A is wirelessly connectable to the corresponding base station 1906A. While a plurality of UEs 1912, 1914 are illustrated in this example, the disclosed embodiments are equally applicable to a situation where a sole UE is in the coverage area or where a sole UE is connecting to the corresponding base station 1906.

The telecommunication network 1900 is itself connected to a host computer 1916, which may be embodied in the hardware and/or software of a standalone server, a cloud-implemented server, a distributed server, or as processing resources in a server farm. The host computer 1916 may be under the ownership or control of a service provider, or may be operated by the service provider or on behalf of the service provider. Connections 1918 and 1920 between the telecommunication network 1900 and the host computer 1916 may extend directly from the core network 1904 to the host computer 1916 or may go via an optional intermediate network 1922. The intermediate network 1922 may be one of, or a combination of more than one of, a public, private, or hosted network; the intermediate network 1922, if any, may be a backbone network or the Internet; in particular, the intermediate network 1922 may comprise two or more sub-networks (not shown).

The communication system of FIG. 19 as a whole enables connectivity between the connected UEs 1912, 1914 and the host computer 1916. The connectivity may be described as an Over-the-Top (OTT) connection 1924. The host computer 1916 and the connected UEs 1912, 1914 are configured to communicate data and/or signaling via the OTT connection 1924, using the access network 1902, the core network 1904, any intermediate network 1922, and possible further infrastructure (not shown) as intermediaries. The OTT connection 1924 may be transparent in the sense that the participating communication devices through which the OTT connection 1924 passes are unaware of routing of uplink and downlink communications. For example, the base station 1906 may not or need not be informed about the past routing of an incoming downlink communication with data originating from the host computer 1916 to be forwarded (e.g., handed over) to a connected UE 1912. Similarly, the base station 1906 need not be aware of the future routing of an outgoing uplink communication originating from the UE 1912 towards the host computer 1916.

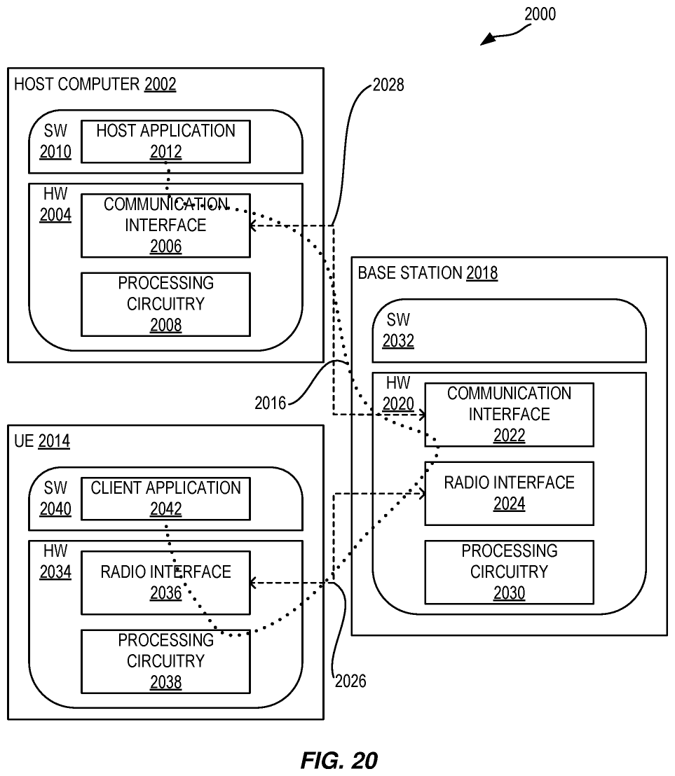

Example implementations, in accordance with an embodiment, of the UE, base station, and host computer discussed in the preceding paragraphs will now be described with reference to FIG. 20. In a communication system 2000, a host computer 2002 comprises hardware 2004 including a communication interface 2006 configured to set up and maintain a wired or wireless connection with an interface of a different communication device of the communication system 2000. The host computer 2002 further comprises processing circuitry 2008, which may have storage and/or processing capabilities. In particular, the processing circuitry 2008 may comprise one or more programmable processors, ASICs, FPGAs, or combinations of these (not shown) adapted to execute instructions. The host computer 2002 further comprises software 2010, which is stored in or accessible by the host computer 2002 and executable by the processing circuitry 2008. The software 2010 includes a host application 2012. The host application 2012 may be operable to provide a service to a remote user, such as a UE 2014 connecting via an OTT connection 2016 terminating at the UE 2014 and the host computer 2002. In providing the service to the remote user, the host application 2012 may provide user data which is transmitted using the OTT connection 2016.

The communication system 2000 further includes a base station 2018 provided in a telecommunication system and comprising hardware 2020 enabling it to communicate with the host computer 2002 and with the UE 2014. The hardware 2020 may include a communication interface 2022 for setting up and maintaining a wired or wireless connection with an interface of a different communication device of the communication system 2000, as well as a radio interface 2024 for setting up and maintaining at least a wireless connection 2026 with the UE 2014 located in a coverage area (not shown in FIG. 20) served by the base station 2018. The communication interface 2022 may be configured to facilitate a connection 2028 to the host computer 2002. The connection 2028 may be direct or it may pass through a core network (not shown in FIG. 20) of the telecommunication system and/or through one or more intermediate networks outside the telecommunication system. In the embodiment shown, the hardware 2020 of the base station 2018 further includes processing circuitry 2030, which may comprise one or more programmable processors, ASICs, FPGAs, or combinations of these (not shown) adapted to execute instructions. The base station 2018 further has software 2032 stored internally or accessible via an external connection.

The communication system 2000 further includes the UE 2014 already referred to. The UE's 2014 hardware 2034 may include a radio interface 2036 configured to set up and maintain a wireless connection 2026 with a base station serving a coverage area in which the UE 2014 is currently located. The hardware 2034 of the UE 2014 further includes processing circuitry 2038, which may comprise one or more programmable processors, ASICs, FPGAs, or combinations of these (not shown) adapted to execute instructions. The UE 2014 further comprises software 2040, which is stored in or accessible by the UE 2014 and executable by the processing circuitry 2038. The software 2040 includes a client application 2042. The client application 2042 may be operable to provide a service to a human or non-human user via the UE 2014, with the support of the host computer 2002. In the host computer 2002, the executing host application 2012 may communicate with the executing client application 2042 via the OTT connection 2016 terminating at the UE 2014 and the host computer 2002. In providing the service to the user, the client application 2042 may receive request data from the host application 2012 and provide user data in response to the request data. The OTT connection 2016 may transfer both the request data and the user data. The client application 2042 may interact with the user to generate the user data that it provides.

It is noted that the host computer 2002, the base station 2018, and the UE 2014 illustrated in FIG. 20 may be similar or identical to the host computer 1916, one of the base stations 1906A, 1906B, 1906C, and one of the UEs 1912, 1914 of FIG. 19, respectively. This is to say, the inner workings of these entities may be as shown in FIG. 20 and independently, the surrounding network topology may be that of FIG. 19.

In FIG. 20, the OTT connection 2016 has been drawn abstractly to illustrate the communication between the host computer 2002 and the UE 2014 via the base station 2018 without explicit reference to any intermediary devices and the precise routing of messages via these devices. The network infrastructure may determine the routing, which may be configured to hide from the UE 2014 or from the service provider operating the host computer 2002, or both. While the OTT connection 2016 is active, the network infrastructure may further take decisions by which it dynamically changes the routing (e.g., on the basis of load balancing consideration or reconfiguration of the network).

The wireless connection 2026 between the UE 2014 and the base station 2018 is in accordance with the teachings of the embodiments described throughout this disclosure. One or more of the various embodiments improve the performance of OTT services provided to the UE 2014 using the OTT connection 2016, in which the wireless connection 2026 forms the last segment. More precisely, the teachings of these embodiments may improve, e.g., latency and/or power consumption and thereby provide benefits such as, e.g., reduced user waiting time, better responsiveness, and/or extended battery lifetime.

A measurement procedure may be provided for the purpose of monitoring data rate, latency, and other factors on which the one or more embodiments improve. There may further be an optional network functionality for reconfiguring the OTT connection 2016 between the host computer 2002 and the UE 2014, in response to variations in the measurement results. The measurement procedure and/or the network functionality for reconfiguring the OTT connection 2016 may be implemented in the software 2010 and the hardware 2004 of the host computer 2002 or in the software 2040 and the hardware 2034 of the UE 2014, or both. In some embodiments, sensors (not shown) may be deployed in or in association with communication devices through which the OTT connection 2016 passes; the sensors may participate in the measurement procedure by supplying values of the monitored quantities exemplified above, or supplying values of other physical quantities from which the software 2010, 2040 may compute or estimate the monitored quantities. The reconfiguring of the OTT connection 2016 may include message format, retransmission settings, preferred routing, etc.; the reconfiguring need not affect the base station 2018, and it may be unknown or imperceptible to the base station 2018. Such procedures and functionalities may be known and practiced in the art. In certain embodiments, measurements may involve proprietary UE signaling facilitating the host computer 2002's measurements of throughput, propagation times, latency, and the like. The measurements may be implemented in that the software 2010 and 2040 causes messages to be transmitted, in particular empty or ‘dummy’ messages, using the OTT connection 2016 while it monitors propagation times, errors, etc.

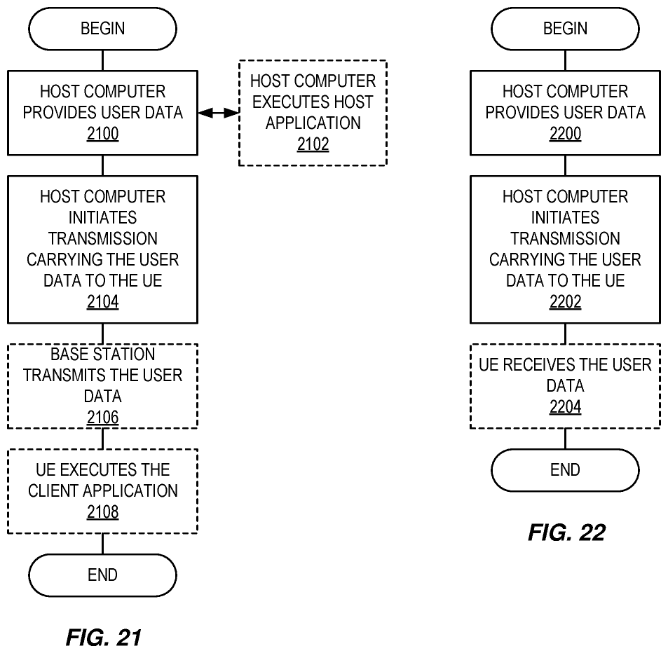

FIG. 21 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 21 will be included in this section. In step 2100, the host computer provides user data. In sub-step 2102 (which may be optional) of step 2100, the host computer provides the user data by executing a host application. In step 2104, the host computer initiates a transmission carrying the user data to the UE. In step 2106 (which may be optional), the base station transmits to the UE the user data which was carried in the transmission that the host computer initiated, in accordance with the teachings of the embodiments described throughout this disclosure. In step 2108 (which may also be optional), the UE executes a client application associated with the host application executed by the host computer.

FIG. 22 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 22 will be included in this section. In step 2200 of the method, the host computer provides user data. In an optional sub-step (not shown) the host computer provides the user data by executing a host application. In step 2202, the host computer initiates a transmission carrying the user data to the UE. The transmission may pass via the base station, in accordance with the teachings of the embodiments described throughout this disclosure. In step 2204 (which may be optional), the UE receives the user data carried in the transmission.

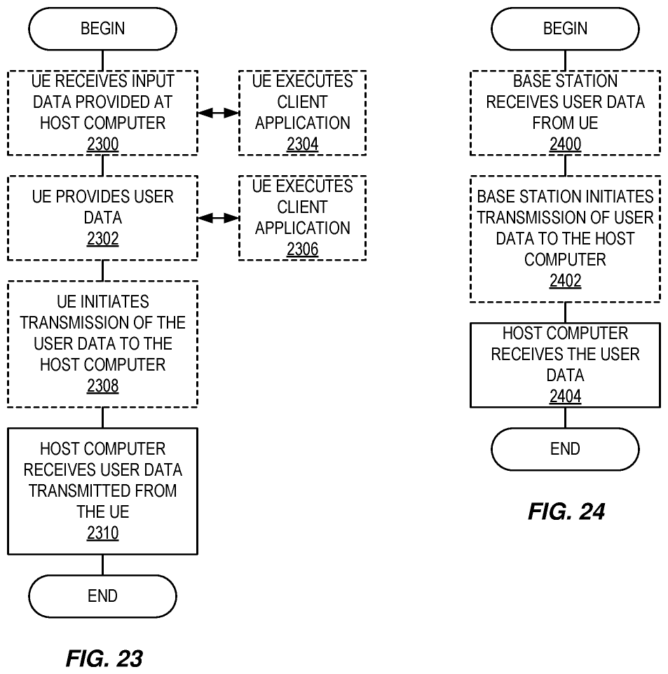

FIG. 23 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 23 will be included in this section. In step 2300 (which may be optional), the UE receives input data provided by the host computer. Additionally or alternatively, in step 2302, the UE provides user data. In sub-step 2304 (which may be optional) of step 2300, the UE provides the user data by executing a client application. In sub-step 2306 (which may be optional) of step 2302, the UE executes a client application which provides the user data in reaction to the received input data provided by the host computer. In providing the user data, the executed client application may further consider user input received from the user. Regardless of the specific manner in which the user data was provided, the UE initiates, in sub-step 2308 (which may be optional), transmission of the user data to the host computer. In step 2310 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 24 will be included in this section. In step 2400 (which may be optional), in accordance with the teachings of the embodiments described throughout this disclosure, the base station receives user data from the UE. In step 2402 (which may be optional), the base station initiates transmission of the received user data to the host computer. In step 2404 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments

Embodiment 1: A method performed by a wireless communication device, WCD, (712), the method comprising:
   receiving (13002), from a RAN node (1300), a Medium Access Control, MAC, Control Element, CE, that comprises information that:
      indicates a plurality of activated TCI states for the WCD (712) comprising at least one DL TCI state and at least one UL TCI state; and
      maps each activated TCI state of the plurality of activated TCI states to one of a plurality of codepoints of a TCI field in a DCI.
Embodiment 2: The method of embodiment 1 further comprising:
   receiving (13004) a DCI comprising a TCI field set to a particular codepoint of the plurality of codepoints of the TCI field;
   determining (13006), from the plurality of activated TCI states, a TCI state to be used for reception of a downlink transmission or transmission of an uplink transmission based on the particular codepoint of the TCI field comprised in the received DCI.
Embodiment 3: The method of embodiment 2 further comprising performing (13008) reception of the downlink transmission or transmission of the uplink transmission based on the determined TCI state.
Embodiment 4: The method of any of embodiments 1 to 3 wherein, for at least one codepoint of the plurality of codepoints of the TCI field, the information comprised in the MAC CE maps an equal number of DL TCI states and UL TCI states to the at least one codepoint.
Embodiment 5: The method of embodiment 4 wherein the equal number of DL TCI states and UL TCI states is one DL TCI state and one UL TCI state.
Embodiment 6: The method of embodiment 4 wherein the equal number of DL TCI states and UL TCI states is two DL TCI states and two UL TCI states.
Embodiment 7: The method of any of embodiments 1 to 6 wherein, for at least one codepoint of the plurality of codepoints of the TCI field, the information comprised in the MAC CE maps different numbers of DL TCI states and UL TCI states to the at least one codepoint.
Embodiment 8: The method of embodiment 7 wherein the different numbers of DL TCI states and UL TCI states is two DL TCI states and one UL TCI state.
Embodiment 9: The method of embodiment 7 wherein the different numbers of DL TCI states and UL TCI states is one DL TCI state and two UL TCI states.
Embodiment 10: The method of any of embodiments 1 to 9 wherein, for at least one codepoint of the plurality of codepoints of the TCI field, the information comprised in the MAC CE maps either one or more DL TCI states or one or more UL TCI states, but not both DL and UL TCI states, to the at least one codepoint.
Embodiment 11: The method of any of embodiments 1 to 10 wherein the information comprised in the MAC CE comprises, for each codepoint of the plurality of codepoints of the TCI field, one or more bits fields comprising:
   a first bit field, where one bit in the first bit field indicates whether the codepoint is mapped to a first DL TCI state;
   a second bit field, where one bit in the second bit field indicates whether the codepoint is mapped to a second DL TCI state;
   a third bit field, where one bit in the third bit field indicates whether the codepoint is mapped to a first UL TCI state;
   a fourth bit field, where one bit in the fourth bit field indicates whether the codepoint is mapped to a second UL TCI state; or
   a combination of any two or more of the first, second, third, and fourth bit fields.
Embodiment 12: The method of any of embodiments 1 to 10 wherein, for at least one codepoint of the plurality of codepoints of the TCI field, the WCD (712) is configured with information that indicates a number of DL TCI states to which the codepoint is mapped, information that indicates a number of UL TCI states to which the codepoint is mapped, or both.
Embodiment 13: The method of any of embodiments 1 to 12 wherein the particular codepoint is mapped to a single DL TCI state in the MAC CE, and the single DL TCI state is applied for all CORESETs configured to the WCD (712).
Embodiment 14: The method of any of embodiments 1 to 12 wherein the particular codepoint is mapped to a single DL TCI state in the MAC CE, and the single DL TCI state is applied for a subset of all CORESETs configured to the WCD (712).
Embodiment 15: The method of any of embodiments 1 to 12 wherein the particular codepoint is mapped to two DL TCI states in the MAC CE, a single CORESET is configured for the WCD (712), and one of the two DL TCI states is applied to the single CORESET.
Embodiment 16: The method of any of embodiments 1 to 12 wherein the particular codepoint is mapped to two DL TCI states in the MAC CE, a single CORESET is configured for the WCD (712), and both of the two DL TCI states are applied to the single CORESET.
Embodiment 17: The method of any of embodiments 1 to 12 wherein the particular codepoint is mapped to two (or more) DL TCI states in the MAC CE, two (or more) CORESETs are configured for the WCD (712), and the two (or more) DL TCI states are applied to the two (or more) CORESETs in a predefined pattern.
Embodiment 18: The method of any of embodiments 1 to 12 wherein the particular codepoint is mapped to two (or more) DL TCI states in the MAC CE, two (or more) CORESETs are configured for the WCD (712), and all of the two (or more) DL TCI states are applied to each of the two (or more) CORESETs.
Embodiment 19: The method of any of embodiments 1 to 12 wherein the particular codepoint is mapped to a single UL TCI state in the MAC CE, a PUCCH resource was activated with a single UL TCI state, and the single UL TCI state activated for the PUCCH resource is updated with the single UL TCI state mapped to the particular codepoint in the MAC CE.
Embodiment 20: The method of any of embodiments 1 to 12 wherein the particular codepoint is mapped to a single UL TCI state in the MAC CE, a PUCCH resource was activated with two (or more) UL TCI states, and one of the two (or more) UL TCI states activated for the PUCCH resource is updated with the single UL TCI state mapped to the particular codepoint in the MAC CE.
Embodiment 21: The method of any of embodiments 1 to 12 wherein the particular codepoint is mapped to two (or more) UL TCI states in the MAC CE, one of the two (or more) UL TCI states is mapped to SRS resources in a first SRS resource set and another of the two (or more) UL TCI states is mapped to SRS resources in a second SRS resource set.
Embodiment 22: The method of embodiment 21 wherein the first and second SRS resource sets are configured for codebook or non-codebook based PUSCH transmissions.
Embodiment 23: The method of any of embodiments 1 to 22 wherein the information comprised in the MAC CE comprises, for each codepoint of the plurality of codepoints of the TCI field:
   one or more first TCI state IDs that indicate one or more activated DL TCI states mapped to the codepoint; and
   one or more second TCI state IDs that indicate one or more activated UL TCI states mapped to the codepoint.
Embodiment 24: The method of any of embodiments 1 to 22 wherein at least one DL TCI state is mapped to each codepoint of the plurality of codepoints of the TCI field, and the information comprised in the MAC CE comprises, for each codepoint of the plurality of codepoints of the TCI field:
   a first bit field that indicates whether a second DL TCI state is mapped to the codepoint in the MAC CE;
   a second bit field that indicates whether a first UL TCI state is mapped to the codepoint in the MAC CE; and
   a third bit field that indicates whether a second UL TCI state is mapped to the codepoint in the MAC CE.
Embodiment 25: The method of any of embodiments 1 to 22 wherein at least one DL TCI state and at least one UL TCI state are mapped to each codepoint of the plurality of codepoints of the TCI field, and the information comprised in the MAC CE comprises, for each codepoint of the plurality of codepoints of the TCI field:
   a first bit field that indicates whether a second DL TCI state is mapped to the codepoint in the MAC CE; and
   a second bit field that indicates whether a second UL TCI state is mapped to the codepoint in the MAC CE.
Embodiment 26: The method of any of embodiments 1 to 22 wherein at least one DL TCI state is mapped to each codepoint of the plurality of codepoints of the TCI, and the information comprised in the MAC CE comprises, for each codepoint of the plurality of codepoints of the TCI field:
   a first bit field that indicates whether a first DL TCI state is mapped to the codepoint in the MAC CE;
   a second bit field that indicates whether a second DL TCI state is mapped to the codepoint in the MAC CE;
   a third bit field that indicates whether a first UL TCI state is mapped to the codepoint in the MAC CE; and
   a fourth bit field that indicates whether a second UL TCI state is mapped to the codepoint in the MAC CE.
Embodiment 27: The method of any of the previous embodiments, further comprising:
   providing user data; and
   forwarding the user data to a host computer via the transmission to the base station.

### Group B Embodiments

Embodiment 28: A method performed by a RAN node (1300), the method comprising:
   sending (13002), to a WCD (712), a Medium Access Control, MAC, Control Element, CE, that comprises information that:
      indicates a plurality of activated TCI states for the WCD (712) comprising at least one DL TCI state and at least one UL TCI state; and
      maps each activated TCI state of the plurality of activated TCI states to one of a plurality of codepoints of a TCI field in a DCI.
Embodiment 29: The method of embodiment 28 further comprising sending (13004), to the WCD (712), a DCI comprising a TCI field set to a particular codepoint of the plurality of codepoints of the TCI field.
Embodiment 30: The method of any of embodiments 28 to 29 wherein, for at least one codepoint of the plurality of codepoints of the TCI field, the information comprised in the MAC CE maps an equal number of DL TCI states and UL TCI states to the at least one codepoint.
Embodiment 31: The method of embodiment 30 wherein the equal number of DL TCI states and UL TCI states is one DL TCI state and one UL TCI state.
Embodiment 32: The method of embodiment 30 wherein the equal number of DL TCI states and UL TCI states is two DL TCI states and two UL TCI states.
Embodiment 33: The method of any of embodiments 28 to 32 wherein, for at least one codepoint of the plurality of codepoints of the TCI field, the information comprised in the MAC CE maps different numbers of DL TCI states and UL TCI states to the at least one codepoint.
Embodiment 34: The method of embodiment 33 wherein the different numbers of DL TCI states and UL TCI states is two DL TCI states and one UL TCI state.
Embodiment 35: The method of embodiment 33 wherein the different numbers of DL TCI states and UL TCI states is one DL TCI state and two UL TCI states.
Embodiment 36: The method of any of embodiments 28 to 35 wherein, for at least one codepoint of the plurality of codepoints of the TCI field, the information comprised in the MAC CE maps either one or more DL TCI states or one or more UL TCI states, but not both DL and UL TCI states, to the at least one codepoint.
Embodiment 37: The method of any of embodiments 28 to 36 wherein the information comprised in the MAC CE comprises, for each codepoint of the plurality of codepoints of the TCI field, one or more bits fields comprising:
   a first bit field, where one bit in the first bit field indicates whether the codepoint is mapped to a first DL TCI state;
   a second bit field, where one bit in the second bit field indicates whether the codepoint is mapped to a second DL TCI state;
   a third bit field, where one bit in the first bit third indicates whether the codepoint is mapped to a first UL TCI state;
   a fourth bit field, where one bit in the fourth bit field indicates whether the codepoint is mapped to a second UL TCI state; or
   a combination of any two or more of the first, second, third, and fourth bit fields.
Embodiment 38: The method of any of embodiments 28 to 36 wherein, for at least one codepoint of the plurality of codepoints of the TCI field, the WCD (712) is configured with information that indicates a number of DL TCI states to which the codepoint is mapped, information that indicates a number of UL TCI states to which the codepoint is mapped, or both.
Embodiment 39: The method of any of embodiments 28 to 38 wherein the information comprised in the MAC CE comprises, for each codepoint of the plurality of codepoints of the TCI field:
   one or more first TCI state IDs that indicate a one or more activated DL TCI states mapped to the codepoint; and
   one or more second TCI state IDs that indicate one or more activated UL TCI states mapped to the codepoint.
Embodiment 40: The method of any of embodiments 28 to 38 wherein at least one DL TCI state is mapped to each codepoint of the plurality of codepoints of the TCI, and the information comprised in the MAC CE comprises, for each codepoint of the plurality of codepoints of the TCI field:
   a first bit field that indicates whether a second DL TCI state is mapped to the codepoint in the MAC CE;
   a second bit field that indicates whether a first UL TCI state is mapped to the codepoint in the MAC CE; and
   a third bit field that indicates whether a second UL TCI state is mapped to the codepoint in the MAC CE.
Embodiment 41: The method of any of embodiments 28 to 38 wherein at least one DL TCI state and at least one UL TCI state are mapped to each codepoint of the plurality of codepoints of the TCI, and the information comprised in the MAC CE comprises, for each codepoint of the plurality of codepoints of the TCI field:
   a first bit field that indicates whether a second DL TCI state is mapped to the codepoint in the MAC CE; and
   a second bit field that indicates whether a second UL TCI state is mapped to the codepoint in the MAC CE.
Embodiment 42: The method of any of embodiments 28 to 38 wherein at least one DL TCI state is mapped to each codepoint of the plurality of codepoints of the TCI field, and the information comprised in the MAC CE comprises, for each codepoint of the plurality of codepoints of the TCI field:
   a first bit field that indicates whether a first DL TCI state is mapped to the codepoint in the MAC CE;
   a second bit field that indicates whether a second DL TCI state is mapped to the codepoint in the MAC CE;
   a third bit field that indicates whether a first UL TCI state is mapped to the codepoint in the MAC CE; and
   a fourth bit field that indicates whether a second UL TCI state is mapped to the codepoint in the MAC CE.
Embodiment 43: The method of any of the previous embodiments, further comprising:
   obtaining user data; and
   forwarding the user data to a host computer or a WCD.

### Group C Embodiments

Embodiment 44: A WCD comprising:
   processing circuitry configured to perform any of the steps of any of the Group A embodiments; and
   power supply circuitry configured to supply power to the WCD.
Embodiment 45: A RAN node comprising:
   processing circuitry configured to perform any of the steps of any of the Group B embodiments; and
   power supply circuitry configured to supply power to the base station.
Embodiment 46: A WCD comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
Embodiment 47: A communication system including a host computer comprising:
   processing circuitry configured to provide user data; and
   a communication interface configured to forward the user data to a cellular network for transmission to a User Equipment, UE;
   wherein the cellular network comprises a base station having a radio interface and processing circuitry, the base station's processing circuitry configured to perform any of the steps of any of the Group B embodiments.
Embodiment 48: The communication system of the previous embodiment further including the base station.
Embodiment 49: The communication system of the previous 2 embodiments, further including the UE, wherein the UE is configured to communicate with the base station.
Embodiment 50: The communication system of the previous 3 embodiments, wherein:
   the processing circuitry of the host computer is configured to execute a host application, thereby providing the user data; and
   the UE comprises processing circuitry configured to execute a client application associated with the host application.
Embodiment 51: A method implemented in a communication system including a host computer, a base station, and a User Equipment, UE, the method comprising:
   at the host computer, providing user data; and
   at the host computer, initiating a transmission carrying the user data to the UE via a cellular network comprising the base station, wherein the base station performs any of the steps of any of the Group B embodiments.
Embodiment 52: The method of the previous embodiment, further comprising, at the base station, transmitting the user data.
Embodiment 53: The method of the previous 2 embodiments, wherein the user data is provided at the host computer by executing a host application, the method further comprising, at the UE, executing a client application associated with the host application.
Embodiment 54: A User Equipment, UE, configured to communicate with a base station, the UE comprising a radio interface and processing circuitry configured to perform the method of the previous 3 embodiments.
Embodiment 55: A communication system including a host computer comprising:
   processing circuitry configured to provide user data; and
   a communication interface configured to forward user data to a cellular network for transmission to a User Equipment, UE;
   wherein the UE comprises a radio interface and processing circuitry, the UE's components configured to perform any of the steps of any of the Group A embodiments.
Embodiment 56: The communication system of the previous embodiment, wherein the cellular network further includes a base station configured to communicate with the UE.
Embodiment 57: The communication system of the previous 2 embodiments, wherein:
   the processing circuitry of the host computer is configured to execute a host application, thereby providing the user data; and
   the UE's processing circuitry is configured to execute a client application associated with the host application.
Embodiment 58: A method implemented in a communication system including a host computer, a base station, and a User Equipment, UE, the method comprising:
   at the host computer, providing user data; and
   at the host computer, initiating a transmission carrying the user data to the UE via a cellular network comprising the base station, wherein the UE performs any of the steps of any of the Group A embodiments.
Embodiment 59: The method of the previous embodiment, further comprising at the UE, receiving the user data from the base station.
Embodiment 60: A communication system including a host computer comprising:
   communication interface configured to receive user data originating from a transmission from a User Equipment, UE, to a base station;
   wherein the UE comprises a radio interface and processing circuitry, the UE's processing circuitry configured to perform any of the steps of any of the Group A embodiments.
Embodiment 61: The communication system of the previous embodiment, further including the UE.
Embodiment 62: The communication system of the previous 2 embodiments, further including the base station, wherein the base station comprises a radio interface configured to communicate with the UE and a communication interface configured to forward to the host computer the user data carried by a transmission from the UE to the base station.
Embodiment 63: The communication system of the previous 3 embodiments, wherein:
   the processing circuitry of the host computer is configured to execute a host application; and
   the UE's processing circuitry is configured to execute a client application associated with the host application, thereby providing the user data.
Embodiment 64: The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
Embodiment 65: A method implemented in a communication system including a host computer, a base station, and a User Equipment, UE, the method comprising:
   at the host computer, receiving user data transmitted to the base station from the UE, wherein the UE performs any of the steps of any of the Group A embodiments.
Embodiment 66: The method of the previous embodiment, further comprising, at the UE, providing the user data to the base station.
Embodiment 67: The method of the previous 2 embodiments, further comprising:
   at the UE, executing a client application, thereby providing the user data to be transmitted; and
   at the host computer, executing a host application associated with the client application.
Embodiment 68: The method of the previous 3 embodiments, further comprising:
   at the UE, executing a client application; and
   at the UE, receiving input data to the client application, the input data being provided at the host computer by executing a host application associated with the client application;
   wherein the user data to be transmitted is provided by the client application in response to the input data.
Embodiment 69: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.
Embodiment 70: The communication system of the previous embodiment further including the base station.
Embodiment 71: The communication system of the previous 2 embodiments, further including the UE, wherein the UE is configured to communicate with the base station.
Embodiment 72: The communication system of the previous 3 embodiments, wherein:
   the processing circuitry of the host computer is configured to execute a host application; and
   the UE is configured to execute a client application associated with the host application, thereby providing the user data to be received by the host computer.
Embodiment 73: A method implemented in a communication system including a host computer, a base station, and a User Equipment, UE, the method comprising:
   at the host computer, receiving, from the base station, user data originating from a transmission which the base station has received from the UE, wherein the UE performs any of the steps of any of the Group A embodiments.
Embodiment 74: The method of the previous embodiment, further comprising at the base station, receiving the user data from the UE.
Embodiment 75: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
BWP Bandwidth Part
CC Component Carrier
CE Control Element
CPU Central Processing Unit
CRB Common Resource Block
CSI-RS Channel State Information Reference Signal
DCI Downlink Control Information
DFT Discrete Fourier Transform
DL Downlink
DMRS Demodulation Reference Signal
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MME Mobility Management Entity
MTC Machine Type Communication
NEF Network Exposure Function
NF Network Function
NR New Radio
NRF Network Function Repository Function
NSSF Network Slice Selection Function
OFDM Orthogonal Frequency Division Multiplexing
OTT Over-the-Top
PC Personal Computer
PCF Policy Control Function
PDCH Physical Data Channel
PDCCH Physical Downlink Control Channel
PDSCH Physical Downlink Shared Channel
P-GW Packet Data Network Gateway
PRB Physical Resource Block
PUCCH Physical Uplink Control Channel
PUSCH Physical Uplink Shared Channel
QCL Quasi Co-Located
QoS Quality of Service
RAM Random Access Memory
RAN Radio Access Network
RE Resource Element
RB Resource Block
ROM Read Only Memory
RRC Radio Resource Control
RRH Remote Radio Head
RTT Round Trip Time
SCEF Service Capability Exposure Function
SINR Signal to Interference plus Noise Ratio
SMF Session Management Function
SRS Sounding Reference Signal
TCI Transmission Configuration Indicator
TRP Transmission and Reception Point
TRS Tracking Reference Signal
UDM Unified Data Management
UE User Equipment
UL Uplink
UPF User Plane Function
WCD Wireless Communication Device

Those skilled in the art will recognize improvements and modifications to the embodiments of the present disclosure. All such improvements and modifications are considered within the scope of the concepts disclosed herein.

1. A method performed by a wireless communication device, WCD, the method comprising:
receiving, from a Radio Access Network, RAN, node, a Medium Access Control, MAC, Control Element, CE, that comprises information that:
indicates a plurality of activated Transmission Configuration Indicator, TCI, states for the WCD comprising at least one Downlink, DL, TCI state and at least one Uplink, UL, TCI state; and
maps each activated TCI state of the plurality of activated TCI states to one of a plurality of codepoints of a TCI field in a Downlink Control Information, DCI.

2. The method of claim 1 further comprising:
receiving a DCI comprising a TCI field set to a particular codepoint of the plurality of codepoints of the TCI field;
determining, from the plurality of activated TCI states, a TCI state to be used for reception of a downlink transmission or transmission of an uplink transmission based on the particular codepoint of the TCI field comprised in the received DCI.

3. The method of claim 2 further comprising performing reception of the downlink transmission or transmission of the uplink transmission based on the determined TCI state.

4. The method of claim 1 wherein, for at least one codepoint of the plurality of codepoints of the TCI field, the information comprised in the MAC CE maps an equal number of DL TCI states and UL TCI states to the at least one codepoint.

5. The method of claim 4 wherein the equal number of DL TCI states and UL TCI states is one DL TCI state and one UL TCI state.

6. The method of claim 5, wherein the information comprised in the MAC CE maps the equal number of DL TCI states and UL TCI states to the at least one codepoint for:
one Component Carrier, CC/DL Bandwidth Part, BWP;
a set of CCs/DL BWPs;
one CC/UL BWP; or
a set of CCs/DL BWPs and CCs/UL BWPs.

7. The method of claim 6, wherein the information comprised in the MAC CE maps the equal number of DL TCI states and UL TCI states to the at least one codepoint for the set of CCs/DL BWPs or the set of CCs/DL BWPs and CCs/UL BWPs; and
the equal number of DL TCI states and UL TCI states are applied to each DL BWP in the set of CCs/DL BWPs or the set of CCs/DL BWPs and CCs/UL BWPs.

8. The method of claim 4 wherein the equal number of DL TCI states and UL TCI states is two DL TCI states and two UL TCI states.

9. The method of claim 1 wherein, for at least one codepoint of the plurality of codepoints of the TCI field, the information comprised in the MAC CE maps different numbers of DL TCI states and UL TCI states to the at least one codepoint.

10. The method of claim 9 wherein the different numbers of DL TCI states and UL TCI states is two DL TCI states and one UL TCI state.

11. The method of claim 10, wherein the two DL TCI states respectively correspond to two beams received from two Transmission/Reception Points, TRPs, in DL, and wherein the one UL TCI state corresponds to a beam transmitted towards one TRP in UL.

12. The method of claim 9 wherein the different numbers of DL TCI states and UL TCI states is one DL TCI state and two UL TCI states.

13. The method of claim 12, wherein the one DL TCI states corresponds to a beam received from a TRPs in DL, and wherein the two UL TCI states respectively correspond to two beams transmitted towards two TRPs in UL.

14. The method of claim 1 wherein, for at least one codepoint of the plurality of codepoints of the TCI field, the information comprised in the MAC CE maps either one or more DL TCI states or one or more UL TCI states, but not both DL and UL TCI states, to the at least one codepoint.

15. The method of claim 1, wherein the information comprised in the MAC CE comprises, for each codepoint of the plurality of codepoints of the TCI field, one or more bits fields comprising:
a first bit field, where one bit in the first bit field indicates whether the codepoint is mapped to a first DL TCI state;
a second bit field, where one bit in the second bit field indicates whether the codepoint is mapped to a second DL TCI state;
a third bit field, where one bit in the third bit field indicates whether the codepoint is mapped to a first UL TCI state;
a fourth bit field, where one bit in the fourth bit field indicates whether the codepoint is mapped to a second UL TCI state; or
a combination of any two or more of the first, second, third, and fourth bit fields.

16. The method of claim 1 wherein, for at least one codepoint of the plurality of codepoints of the TCI field, the WCD is configured with information that indicates a number of DL TCI states to which the codepoint is mapped, information that indicates a number of UL TCI states to which the codepoint is mapped, or both.

17. The method of claim 1, wherein the particular codepoint is mapped to a single DL TCI state in the MAC CE, and the single DL TCI state is applied for all CORESETs configured to the WCD.

18. The method of claim 1, wherein the particular codepoint is mapped to a single DL TCI state in the MAC CE, and the single DL TCI state is applied for a subset of all CORESETs configured to the WCD.

19. The method of claim 1, wherein the particular codepoint is mapped to two DL TCI states in the MAC CE, a single CORESET is configured for the WCD, and one of the two DL TCI states is applied to the single CORESET.

20. The method of claim 1, wherein the particular codepoint is mapped to two DL TCI states in the MAC CE, a single CORESET is configured for the WCD, and both of the two DL TCI states are applied to the single CORESET.

21. The method of claim 1, wherein the particular codepoint is mapped to two (or more) DL TCI states in the MAC CE, two (or more) CORESETs are configured for the WCD, and the two (or more) DL TCI states are applied to the two (or more) CORESETs in a predefined pattern.

22. The method of claim 1, wherein the particular codepoint is mapped to two (or more) DL TCI states in the MAC CE, two (or more) CORESETs are configured for the WCD, and all of the two (or more) DL TCI states are applied to each of the two (or more) CORESETs.

23. The method of claim 1, wherein the particular codepoint is mapped to a single UL TCI state in the MAC CE, a Physical Uplink Control Channel, PUCCH, resource was activated with a single UL TCI state, and the single UL TCI state activated for the PUCCH resource is updated with the single UL TCI state mapped to the particular codepoint in the MAC CE.

24. The method of claim 1, wherein the particular codepoint is mapped to a single UL TCI state in the MAC CE, a Physical Uplink Control Channel, PUCCH, resource was activated with two (or more) UL TCI states, and one of the two (or more) UL TCI states activated for the PUCCH resource is updated with the single UL TCI state mapped to the particular codepoint in the MAC CE.

25. The method of claim 1, wherein the particular codepoint is mapped to two (or more) UL TCI states in the MAC CE, one of the two (or more) UL TCI states is mapped to Sounding Reference Signal, SRS, resources in a first SRS resource set and another of the two (or more) UL TCI states is mapped to SRS resources in a second SRS resource set.

26. The method of claim 25 wherein the first and second SRS resource sets are configured for codebook or non-codebook based Physical Uplink Shared Channel, PUSCH, transmissions.

27. The method of claim 1, wherein the information comprised in the MAC CE comprises, for each codepoint of the plurality of codepoints of the TCI field:
one or more first TCI state IDs that indicate one or more activated DL TCI states mapped to the codepoint; and
one or more second TCI state IDs that indicate one or more activated UL TCI states mapped to the codepoint.

28. The method of claim 1, wherein at least one DL TCI state is mapped to each codepoint of the plurality of codepoints of the TCI field, and the information comprised in the MAC CE comprises, for each codepoint of the plurality of codepoints of the TCI field:
a first bit field that indicates whether a second DL TCI state is mapped to the codepoint in the MAC CE;
a second bit field that indicates whether a first UL TCI state is mapped to the codepoint in the MAC CE; and
a third bit field that indicates whether a second UL TCI state is mapped to the codepoint in the MAC CE.

29. The method of claim 1, wherein at least one DL TCI state and at least one UL TCI state are mapped to each codepoint of the plurality of codepoints of the TCI field, and the information comprised in the MAC CE comprises, for each codepoint of the plurality of codepoints of the TCI field:
a first bit field that indicates whether a second DL TCI state is mapped to the codepoint in the MAC CE; and
a second bit field that indicates whether a second UL TCI state is mapped to the codepoint in the MAC CE.

30. The method of claim 1, wherein at least one DL TCI state is mapped to each codepoint of the plurality of codepoints of the TCI, and the information comprised in the MAC CE comprises, for each codepoint of the plurality of codepoints of the TCI field:
a first bit field that indicates whether a first DL TCI state is mapped to the codepoint in the MAC CE;
a second bit field that indicates whether a second DL TCI state is mapped to the codepoint in the MAC CE;
a third bit field that indicates whether a first UL TCI state is mapped to the codepoint in the MAC CE; and
a fourth bit field that indicates whether a second UL TCI state is mapped to the codepoint in the MAC CE.

31. (canceled)

32. (canceled)

33. A wireless communication device, WCD, comprising:
one or more transmitters;
one or more receivers; and
processing circuitry, wherein the processing circuitry is configured to cause the WCD to:
receive, from a Radio Access Network, RAN, node, a Medium Access Control, MAC, Control Element, CE, that comprises information that:
indicates a plurality of activated Transmission Configuration Indicator, TCI, states for the WCD comprising at least one Downlink, DL, TCI state and at least one Uplink, UL, TCI state; and
maps each activated TCI state of the plurality of activated TCI states to one of a plurality of codepoints of a TCI field in a Downlink Control Information, DCI.

34. (canceled)

35. A method performed by a Radio Access Network, RAN, node, the method comprising:
sending, to a Wireless Communication Device, WCD, a Medium Access Control, MAC, Control Element, CE, that comprises information that:
indicates a plurality of activated Transmission Configuration Indicator, TCI, states for the WCD comprising at least one Downlink, DL, TCI state and at least one Uplink, UL, TCI state; and
maps each activated TCI state of the plurality of activated TCI states to one of a plurality of codepoints of a TCI field in a DCI.

36-55. (canceled)

56. A Radio Access Network, RAN, node, comprising:
one or more transmitters;
one or more receivers; and
processing circuitry, wherein the processing circuitry is configured to cause the RAN node to:
send, to a Wireless Communication Device, WCD, a Medium Access Control, MAC, Control Element, CE, that comprises information that:
indicates a plurality of activated Transmission Configuration Indicator, TCI, states for the WCD comprising at least one Downlink, DL, TCI state and at least one Uplink, UL, TCI state; and
maps each activated TCI state of the plurality of activated TCI states to one of a plurality of codepoints of a TCI field in a DCI.

57. (canceled)
